(19) United States
(12) Patent Application Publication
(10) Pub. No.: US 2013/0183898 A1
(43) Pub. Date: Jul. 18, 2013

(54) SYSTEMS AND METHODS FOR NON-CONTACT POWER AND DATA TRANSFER IN ELECTRONIC DEVICES

(71) Applicant: Eric W. Strid, Portland, OR (US)

(72) Inventor: Eric W. Strid, Portland, OR (US)

(73) Assignee: Cascade Microtech, Inc, Beaverton, OR (US)

(21) Appl. No.: 13/822,611

(22) PCT Filed: Sep. 16, 2011
(86) PCT No.: PCT/US11/51899

§ 371 Date: Mar. 12, 2013

Related U.S. Application Data
(60) Provisional application No. 61/384,114, filed on Sep. 17, 2010.

(51) Int. Cl. H04B 5/00

(52) U.S. Cl. CPC H04B 5/0031; H04B 5/0037
USPC 455/41.1; 307/104

(57) ABSTRACT

Systems and methods for non-contact and/or wireless transmission of power and/or data between and/or within electronic devices. These systems and methods may include the use of two or more wireless power modules to transmit a wireless power signal between a first electronic device and a second electronic device and/or the use of two or more wireless data modules to transmit a wireless data signal between the first electronic device and the second electronic device. The wireless power modules and/or the wireless data modules may include one or more near-field coupling devices. The wireless power modules and/or wireless data modules associated with the first electronic device may be arranged in complementary locations to the wireless power modules and/or wireless data modules associated with the second electronic device and the complementary modules may be separated by a distance of less than 10 um.

### RELATED APPLICATION

This application claims priority to U.S. Provisional Patent Application Ser. No. 61/384,114, which was filed on Sep. 17, 2010, and the complete disclosure of which is hereby incorporated by reference.

### FIELD OF THE DISCLOSURE

The present disclosure is directed to systems and methods for providing power to and/or data communication with an electronic device without forming an electrical connection with the electronic device.

### BACKGROUND OF THE DISCLOSURE

The trend in electronic device production, particularly in integrated circuit technology, has been toward fabricating larger numbers of discrete circuit elements with higher operating frequencies and smaller circuit element geometries on a single device substrate. After these devices are fabricated, they may be subject to various electrical tests to verify functionality, quantify operating characteristics, and/or characterize the manufacturing process. Additionally or alternatively, the devices may be packaged for communication with other devices and/or electronic components.

Traditionally, the electrical tests have been performed by forming a plurality of electrical contacts with a device under test (DUT) and providing electric current to the DUT in the form of input power and/or test signals, as well as receiving electric current from the DUT in the form of output, or resultant, signals. The response of the DUT to various input test signals and/or power levels may then be quantified through analysis of the input and/or output signals.

However, as a density of the individual circuit elements increases, a density and/or number of bond and/or contact pads that may be contacted to perform the electrical testing also may increase. Also, a pitch and/or spacing between adjacent pads may decrease and/or a size of the individual pads may decrease. Each of these changes increases the complexity of a contact test system.

In addition, as the electronic device industry pursues further advancement, new and/or different manufacturing methods and/or assembly architectures may present additional testing, assembly, and/or packaging challenges. As an illustrative, non-exclusive example, three-dimensional (3-D) electronic device architectures have been proposed in which two or more individual chips, dies, and/or tiers may be stacked together in a face-to-face arrangement. In these 3-D architectures, each individual tier may include a large number of contact pads, and a failure in a single tier may render the entire device nonfunctional. Thus, there exists a need for testing systems and methods that may test individual tiers prior to assembly in a final 3-D stack of integrated circuit chips, for reliable assembly systems and methods, and/or for systems and methods that may provide for removal of a defective tier from the 3-D stack of integrated circuit chips.

Furthermore, forming an electrical contact may result in damage to the pads present on a DUT, and this damage may preclude the subsequent use of that pad to form an electrical connection from the DUT. Thus, there exists a need for systems and/or methods that may provide for non-contact power and/or data transfer to and/or from a DUT and/or between and/or among the various tiers of a 3-D electronic device.

### SUMMARY OF THE DISCLOSURE

Systems and methods for non-contact and/or wireless transmission of power and/or data between and/or within electronic devices. These systems and methods may include the use of two or more wireless power modules to transmit a wireless power signal between a first electronic device and a second electronic device and/or the use of two or more wireless data modules to transmit a wireless data signal between the first electronic device and the second electronic device. The wireless power modules and/or the wireless data modules may include one or more near-field coupling devices. The wireless power modules and/or wireless data modules associated with the first electronic device may be arranged in complementary locations to the wireless power modules and/or wireless data modules associated with the second electronic device and the complementary modules may be separated by a separation distance of less than 10 um.

In some embodiments, a first substrate for the first electronic device may be different from a second substrate for the second electronic device. In some embodiments, the first substrate may have a different chemical composition and/or a different method of manufacturing than the second substrate. In some embodiments, the near-field coupling devices may include an inductor, a capacitor, an optical detector, an optical emitter, and/or a waveguide that may be configured to transfer a wireless signal across the separation distance. In some embodiments, the first electronic device and the second electronic device include a plurality of near-field power coupling devices. In some embodiments, the first electronic device and/or the second electronic device includes a coupling control device configured to control a portion of the near-field coupling devices that are utilized to transmit the wireless signal.

### BRIEF DESCRIPTION OF THE DRAWINGS

FIG. 1 is a schematic representation of illustrative, non-exclusive examples of electronic devices according to the present disclosure.

FIG. 2 is another schematic representation of illustrative, non-exclusive examples of electronic devices according to the present disclosure.

FIG. 3 is a schematic representation of illustrative, non-exclusive examples of an inductive near-field coupling device according to the present disclosure.

FIG. 4 is a schematic representation of illustrative, non-exclusive examples of a capacitive near-field coupling device according to the present disclosure.

FIG. 5 is a schematic representation of illustrative, non-exclusive examples of an optical coupling device according to the present disclosure.

FIG. 6 is a schematic representation of an illustrative, non-exclusive example of an array of near-field coupling devices according to the present disclosure.

FIG. 7 is a schematic representation of illustrative, non-exclusive examples of wireless power modules according to the present disclosure.

FIG. 8 is a schematic representation of illustrative, non-exclusive examples of wireless data modules according to the present disclosure that may be configured to transfer a radio frequency data signal with a wireless data signal.

FIG. 9 is a schematic representation of illustrative, non-exclusive examples of wireless data modules according to the present disclosure that may be configured to transfer a digital data signal or a low frequency data signal with the wireless data signal.

FIG. 10 is a schematic representation of illustrative, non-exclusive examples of an assembly of two electronic devices according to the present disclosure.

FIG. 11 is another schematic representation of illustrative, non-exclusive examples of an assembly of electronic devices according to the present disclosure.

FIG. 12 is a schematic representation of illustrative, non-exclusive examples of a three-dimensional integrated circuit according to the present disclosure.

FIG. 13 is a schematic representation of an illustrative, non-exclusive example of a dual-zone probe head according to the present disclosure.

FIG. 14 is a flowchart depicting methods of wirelessly transferring power and/or data signals according to the present disclosure.

### DETAILED DESCRIPTION AND BEST MODE OF THE DISCLOSURE

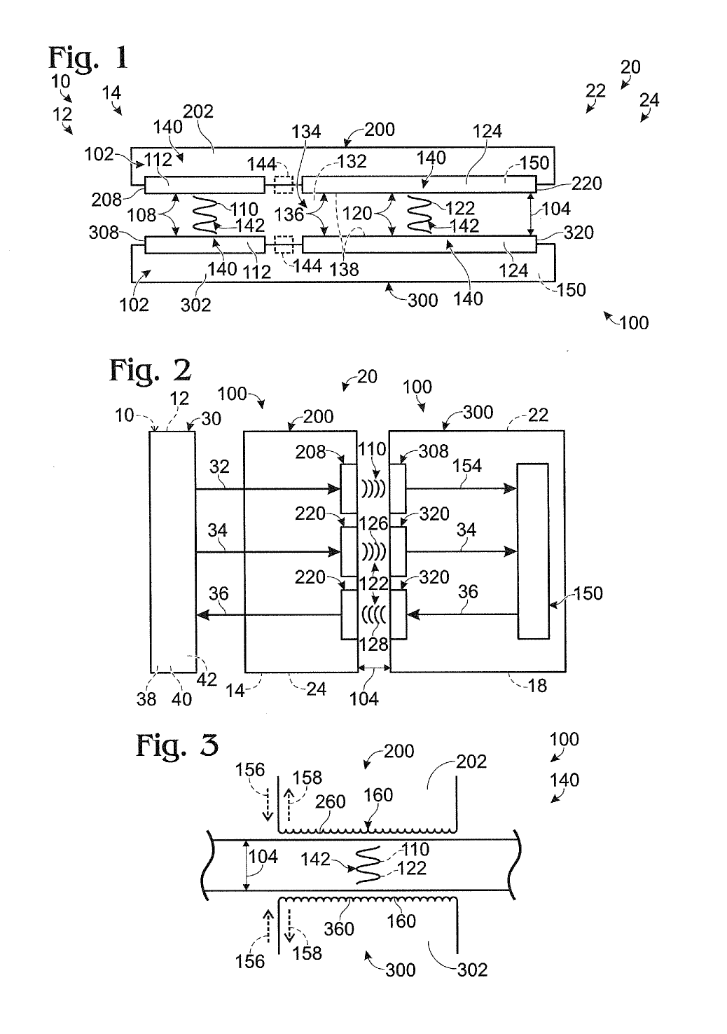

FIG. 1 is a schematic representation of illustrative, non-exclusive examples of electronic devices 100 according to the present disclosure. As discussed in more detail herein, electronic devices 100 may be included in, and/or form a portion of, a test system 10, which also may be referred to herein as a probe station. The test system may be configured to perform one or more test sequences, such as by providing one or more input data signals to a device under test and/or by receiving one or more resultant, or output, signals from the device under test. As illustrative, non-exclusive examples, electronic devices 100 may form a portion of a probe head 12 and/or a test tier 14 that may be in electrical communication with, and/or form a portion of, test system 10.

Additionally or alternatively, electronic devices 100 may he included in, and/or form a portion of, a three-dimensional (3-D) integrated circuit 20, which may be utilized in any suitable electronic device. As an illustrative, non-exclusive example, electronic devices 100 may he, and/or form a portion of, a logic tier 22, which may be configured to perform one or more logical operations. Logic tier 22 additionally or alternatively may be referred to herein as, and/or form a portion of, a logic device, a memory device, a microprocessor, and/or an integrated circuit. As another illustrative, non-exclusive example, electronic devices 100 may be, and/or form a portion of, a power supply tier 24, which may be configured to provide power to and/or to send and/or receive data from logic tier 22.

In FIG. 1, a pair of electronic devices 100 is shown and indicated as first electronic device 200 and second electronic device 300. First electronic device 200 is separated from second electronic device 300 by a separation distance 104. Electronic devices 100 may be formed on substrates 102, which may be referred to individually as first substrate 202 and second substrate 302, respectively, and which may include a plurality of electronic structures, including wireless power modules 108. Wireless power modules 108 may be referred to individually as first wireless power module 208 and second wireless power module 308, respectively. In addition, electronic devices 100 also may include wireless data modules 120, which may be referred to individually as first wireless data module 220 and second wireless data module 320, respectively.

Wireless power modules 108 may he configured to transfer a wireless power signal 110 across separation distance 104 and between first electronic device 200 and second electronic device 300. Similarly, wireless data modules 120 may be configured to transfer a wireless data signal 122 across separation distance 104 and between first electronic device 200 and second electronic device 300.

Wireless power signal 110 and wireless data signal 122, which may be referred to herein collectively and/or generically as wireless signals 142, may be transferred across separation distance 104 and between first electronic device 200 and second electronic device 300 without the use of an electrical conduit to transfer, or conduct, electrons and/or an electric current between the first electronic device and the second electronic device. Additionally or alternatively, the wireless signals may be transferred across separation distance 104 without electrical contact, physical contact, net electric current flow, and/or electrical conduction between first electronic device 200 and second electronic device 300. Illustrative, non-exclusive examples of wireless signals include any suitable electric field, magnetic field, and/or electromagnetic radiation.

A volume 134 between first electronic device 200 and second electronic device 300, a thickness of which may be defined by separation distance 104, may include a dielectric material 132 that is configured to electrically isolate first electronic device 200 from second electronic device 300 and/or to provide a dielectric medium for the transfer of wireless signals 142 between first electronic device 200 and second electronic device 300. Illustrative, non-exclusive examples of dielectric materials according to the present disclosure include materials with a dielectric constant of at least 1, such as air, as well as materials with a dielectric constant of at least 2, at least 4, at least 6, at least 8, at least 10, at least 12, at least 14, at least 16, at least 18, at least 20, at least 30, at least 50, or at least 100.

In addition to serving as a dielectric medium for the transfer of wireless signals 142, dielectric material optionally may be utilized for other purposes. As an illustrative, non-exclusive example, dielectric material 132 may include a dielectric fluid that may function as a heat exchange fluid and may be circulated through volume 134 to remove thermal energy from at least first electronic device 200 and/or second electronic device 300. Moreover, as heat removal from electronic devices 100 may represent a design constraint, the absence of electrical conductors bridging separation distance 104 between the first electronic device and the second electronic device may provide for improved fluid circulation therebetween. As another illustrative, non-exclusive example, the dielectric fluid may be provided to a sampling device, which may be configured to detect any suitable property of the dielectric fluid that may be indicative of the performance of electronic devices 100.

At least a portion of a surface 136 of first electronic device 200 and/or second electronic device 300 that bounds or otherwise abuts or borders volume 134 may include and/or be a passivated surface 138. Illustrative, non-exclusive examples of passivated surfaces according to the present disclosure include surfaces that are coated with an electrically insulating material, a dielectric coating, a dielectric film, a polymeric material, and/or an oxide. Illustrative, non-exclusive examples of portions of surface 136 that may include and/or be passivated surface 138 include all of surface 136 and the portions of surface 136 that receive the wireless signals, such as any and/or all electrically conductive portions thereof.

As shown in FIG. 1 and discussed in more detail herein, first electronic device 200 and second electronic device 300 may be present on separate substrates 202 and 302, respectively. It is within the scope of the present disclosure that first substrate 202 and second substrate 302 may include a similar, or at least substantially similar, composition and/or materials of construction. However, it is also within the scope of the present disclosure that first substrate 202 and second substrate 302 may include a different, or at least substantially different, composition and/or materials of construction. Illustrative, non-exclusive examples of substrates 102 according to the present disclosure include silicon, gallium arsenide, and/or germanium.

The plurality of electronic structures present on and/or in substrates 102, such as wireless power modules 108 and/or wireless data modules 120, may be constructed, placed, and/or otherwise formed on substrates 102 in any suitable manner. As an illustrative, non-exclusive example, at least a portion of the plurality of electronic structures may be formed separately from and operatively attached to the substrates, such as through the use of any suitable adhesive, weld, and/or alloying process. As another illustrative, non-exclusive example, at least a portion of the plurality of electronic structures may be formed on and/or formed from the substrates. This may include forming the electronic structures using any suitable process, illustrative, non-exclusive examples of which include semiconductor manufacturing processes such as deposition, etching, implant, annealing, and/or epitaxial growth. Thus, it is within the scope of the present disclosure that at least a portion of the individual components, assemblies, and/or portions of electronic devices 100, which may be referred to herein as modules, may be formed separately from one each other and/or may he formed at least partially together, concurrently, and/or simultaneously, such as may be the case when the modules are fabricated using semiconductor manufacturing processes.

Separation distance 104 may include any suitable separation distance between first wireless power module 208 and second wireless power module 308 and/or between first wireless data module 220 and second wireless data module 320 that may provide for the transfer of wireless power signal 110 and/or wireless data signal 122, respectively, between first electronic device 200 and second electronic device 300. Illustrative, non-exclusive examples of separation distances according to the present disclosure include separation distances of less than 10 micrometers (um), including separation distances of less than 8, less than 6, less than 5, less than 4, less than 3, less than 2, less than 1, less than 0.5, less than 0.25, or less than 0.1 um. Additionally or alternatively, and when the wireless signals include electromagnetic radiation, the separation distance may be less than a wavelength of the electromagnetic radiation, such as less than 75%, less than 50%, less than 40%, less than 30%, less than 25%, less than 20%, less than 10%, less than 5%, or less than 1% of the wavelength of the electromagnetic radiation.

The above separation distances may, additionally or alternatively, be referred to as maximum separation distances and/or as maximum values for a distance between first electronic device 200 and second electronic device 300 and/or the components thereof. The spatial relationship between first electronic device 200 and second electronic device 300 also may be determined and/or defined by a minimum separation distance between first electronic device 200 and second electronic device 300 and/or between the components thereof. Illustrative, non-exclusive examples of minimum separation distances according to the present disclosure include minimum separation distances of at least 0.01 um, at least 0.025 um, at least 0.05 um, at least 0.075 um, at least 0.1 um, at least 0.25 um, at least 0.5 um, or at least 1 um. Any suitable range of separation distances, including ranges that are within the above minimum and maximum values, as well as ranges that are less than the above minimum values and/or greater than the above maximum values are also within the scope of the present disclosure.

Wireless power modules 108 and/or wireless data modules 120 may include and/or be in electrical communication with one or more near-field coupling devices 140, such as near-field power coupling devices 112 and/or near-field data coupling devices 124 that are configured to transfer wireless power signal 110 between first wireless power module 208 and second wireless power module 308 and/or to transfer wireless data signal 122 between first wireless data module 220 and second wireless data module 320. When wireless power module 108 and/or wireless data module 120 includes more than one near-field coupling device 140, which also may be referred to herein as a plurality of near-field coupling devices 140, each near-field coupling device associated with first electronic device 200 may be configured to transfer a respective wireless signal to, and/or receive a respective wireless signal from, a complementary near-field coupling device associated with second electronic device 300.

Wireless power modules 108 and/or wireless data modules 120 may include any suitable number of near-field coupling devices, including at least 1000, at least 5000, at least 10,000, at least 25,000, at least 50,000, at least 100,000, at least 250,000, at least 500,000, or at least 1,000,000 near-field coupling devices. Similarly, first electronic device 200 and/or second electronic device 300 may include any suitable number of wireless power modules 108 and/or wireless data modules 120.

Near-field coupling devices 140 may include any suitable structure that is configured to transfer wireless signals 142 between first electronic device 200 and second electronic device 300. As an illustrative, non-exclusive example, the near-field coupling devices may be configured to receive an AC signal and to produce one or more wireless signals 142 therefrom. As another illustrative, non-exclusive example, the near-field coupling devices may be configured to receive one or more wireless signals 142 and to produce an AC signal therefrom. Illustrative, non-exclusive examples of near-field coupling devices are discussed in more detail herein.

Wireless power modules 108 and/or wireless data modules 120 may include any suitable structure that is configured to receive the AC signal from near-field coupling devices 140 and/or provide the AC signal to near-field coupling devices 140. Illustrative, non-exclusive examples of wireless power modules 108 according to the present disclosure may include any suitable inductor, capacitor, switching regulator, AC to DC converter, and/or amplifier, and are discussed in more detail herein. When the wireless power module includes an AC to DC converter, the wireless power module may be configured to receive the AC signal from the near-field coupling device and to produce a DC signal therefrom.

To increase an efficiency of transmission of wireless power signal 110 and/or wireless data signal 122 between first electronic device 200 and second electronic device 300, an alignment of the first electronic device with respect to the second electronic device, such as between the wireless power modules 108, wireless data modules 120, and/or near-field coupling devices 140 thereof, may be important. Thus, first electronic device 200 and/or second electronic device 300 optionally may include one or more alignment marks, or indicia, 144 that are configured to increase an accuracy of alignment between the first electronic device and the second electronic device. Illustrative, non-exclusive examples of alignment marks 144 according to the present disclosure include any suitable optically visible reference structure, electrically detected reference structure, and/or lithographically defined reference structure.

Additionally or alternatively, one or more characteristics of wireless signals 142, such as signal strength and/or signal transmission efficiency, may be monitored to increase alignment accuracy. As an illustrative, non-exclusive example, one or more differential capacitance sensors may be utilized to sense spacing and/or alignment between first electronic device 200 and second electronic device 300.

As discussed in more detail herein, electronic devices 100, such as first electronic device 200 and/or second electronic device 300, may, in addition to wireless power modules 108 and/or wireless data modules 120, include any other suitable structure and/or serve and/or perform any other suitable function. As an illustrative, non-exclusive example, electronic devices 100 may be and/or include logic tier 22 that is configured to perform one or more logical operations. Logic tier 22 may include wireless power module 108, wireless data module 120, and one or more logic devices 150. The wireless power module of logic tier 22 may be configured to receive the wireless power signal and to produce the DC signal therefrom. Logic devices 150 may be configured to be powered by the DC signal, to receive an input data signal (which may be produced from a portion of the wireless data signal) from wireless data module 120, and/or to provide an output data signal, which may form a portion of the wireless data signal, to wireless data module 120. Illustrative, non-exclusive examples of logic circuits according to the present disclosure include any suitable electronic circuit, logic circuit, integrated circuit, digital circuit, and/or analog circuit.

As another illustrative, non-exclusive example, electronic devices 100 also may be and/or include power supply tier 24. Power supply tier 24 may he configured to provide power to one or more logic tiers 22, such as through the generation of wireless power signal 110, which may he supplied to the logic tier by the power supply tier. Illustrative, non-exclusive examples of power supply tiers 24 are discussed in more detail herein.

As yet another illustrative, non-exclusive example, electronic devices 100 also may be and/or include test tier 14. Test tier 14 may he configured to provide wireless power signal 110 to one or more devices under test (DUTs), receive one or more wireless data signals 122 from one or more DUTs, and/or provide one or more wireless data signals to one or more DUTs. As discussed in more detail herein, the test tier may be in electrical communication with test system 10, which may provide one or more power and/or input data signals to the lest tier and/or receive one or more resultant data signals from the test tier. Additionally or alternatively, test tier 14 also may incorporate and/or include test functionality that may be independent from, and/or work in conjunction with, test system 10.

Illustrative, non-exclusive examples of DUTs according to the present disclosure include any suitable electronic device 100, such as logic tier 22 and/or power supply tier 24. DUTs according to the present disclosure may include a single electronic device 100.

Additionally or alternatively, DUTs according to the present disclosure may include a plurality of discrete electronic devices that form a portion of an integrated circuit chip, a 3-D stack of integrated circuit chips, a plurality of singulated integrated circuit chips, and/or a plurality of integrated circuit chips that have not yet been singulated.

FIG. 2 is another schematic representation of illustrative, non-exclusive examples of electronic devices 100 according to the present disclosure. In FIG. 2, first electronic device 200 is separated from second electronic device 300 by separation distance 104. The first electronic device is configured to receive electric current 32 from support circuitry 30, to utilize first wireless power module 208 to produce wireless power signal 110 therefrom, and to provide the wireless power signal to second wireless power module 308 of second electronic device 300. Second wireless power module 308 may receive wireless power signal 110 and produce DC signal 154 therefrom, which may be utilized to provide power to logic device 150.

In addition, first electronic device 200 of FIG. 2 also is configured to receive input data signal 34 from support circuitry 30, to utilize first wireless data module 220 to produce data signal 122 (such as wireless input data signal 126) therefrom, and to supply the wireless input data signal to second wireless data module 320 of second electronic device 300. Second wireless data module 320 may reproduce input data signal 34 and provide the input data signal to logic device 150.

Logic device 150 may be configured to produce output data signal 36 from input data signal 34 and to provide the output data signal to second wireless data module 320, which may produce wireless output data signal 128 therefrom. First wireless data module 220 of first electronic device 200 may be configured to receive the wireless output data signal and to reproduce output data signal 36 therefrom, which may be provided to support circuitry 30.

In FIG. 2, first electronic device 200 also may include, be, and/or be referred to as power supply tier 24, powering tier 24, and/or test tier 14. When first electronic device 200 is or includes power supply tier 24, first electronic device 200 and second electronic device 300 may form a portion of and/or be a 3-D integrated circuit 20, and support circuitry 30 may be and/or include any suitable circuitry that is configured to provide electric current 32 and input data signal 34 to and/or receive output data signal 36 from the 3-D integrated circuit. Illustrative, non-exclusive examples of support circuitry 30 include any suitable portion of electronic device 200, motherboard, circuit board, printed circuit board, personal computer, portable electronic device, stationary electronic device, communication device, and/or portable communication device.

Additionally and/or alternatively, first electronic device 200 also may include, be, and/or be referred to as test tier 14. When first electronic device 200 is or includes test tier 14, support circuitry 30 may be and/or include any suitable test system 10 and/or probe head 12 that is configured perform a test sequence on second electronic device 300, which may include DUT 18, power supply tier 24, and/or logic tier 22.

While not required to all embodiments, as indicated in FIG. 2, test tier 14 may include one or more wired power connections 70 that may be configured to provide electric current and/or electric power to the test tier, which may produce the wireless power signal therefrom. Similarly, the test tier also may include one or more wired input connections 72 that may be configured to receive an input data signal from a test system, to produce an input portion of the wireless data signal from the input data signal, and to provide the input portion of the wireless data signal to the device under test. The test tier also may include one or more wired output connections 74 that may be configured to provide an output data signal to the test system.

Illustrative, non-exclusive examples of test systems 10 according to the present disclosure include any suitable signal generator 38 that is configured to produce input data signal 34, signal analyzer 40 that is configured to receive and/or analyze output data signal 36, and/or power source 42 that is configured to provide electric current 32 to first electronic device 200. Illustrative, non-exclusive examples of test sequences according to the present disclosure include any suitable voltage and/or current for DC signal 154 and/or any suitable voltage and/or current for input data signal 34 that may test, validate, and/or otherwise categorize the operation of second electronic device 300.

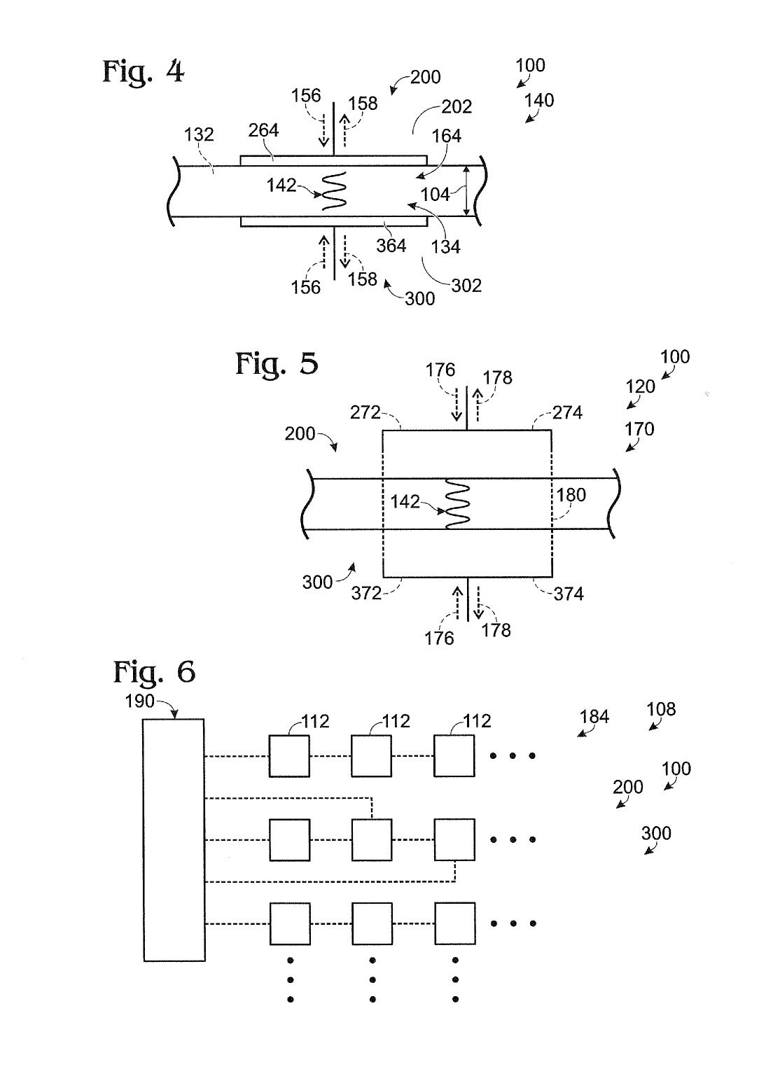

FIGS. 3-4 provide illustrative, non-exclusive examples of electronic devices 100 that include near-field coupling devices 140 that may be utilized with the systems and methods according to the present disclosure. In FIGS. 3-4, the near-field coupling devices may be utilized to transfer wireless power signals and/or wireless data signals between first electronic device 200 and second electronic device 300 by generating wireless signal 142 from an input AC signal 156, transmitting the wireless signal across separation distance 104, receiving the wireless signal in a complementary near-field coupling device, and producing an output AC signal 158 from the wireless signal.

FIG. 3 is a schematic representation of illustrative, non-exclusive examples of a near-field coupling device 140 in the form of an inductive near-field coupling device. In FIG. 3, first electronic device 200 and second electronic device 300 include first inductor 260 and second inductor 360 on first substrate 202 and second substrate 302, respectively. First inductor 260 and/or second inductor 360 may be configured to produce wireless signal 142, which may include wireless power signal 110 and/or wireless data signal 122 and/or to receive the respective wireless signals. When input AC signal 156 is supplied to inductors 160, the inductors may produce wireless signal 142, in the form of a magnetic field, therefrom. The wireless signal may be transmitted across separation distance 104 and be received by a complementary inductor, which may produce output AC signal 158 therefrom.

FIG. 4 is a schematic representation of illustrative, non-exclusive examples of a near-field coupling device 140 in the form of a capacitive near-field coupling device. In FIG. 4, first electronic device 200 includes a first conductive surface 264 and second electronic device 300 includes a second conductive surface 364. First conductive surface 264 and second conductive surface 364 are separated by separation distance 104 and form a capacitor 164. Volume 134 between the surfaces may include dielectric material 132. When input AC signal 156 is supplied to one of the conductive surfaces of capacitor 164, the conductive surface may produce wireless signal 142, in the form of an electric field, therefrom. The wireless signal may be transmitted across separation distance 104 and he received by the other conductive surface of capacitor 164, which may produce output AC signal 158 therefrom.

FIG. 5 is a schematic representation of illustrative, non-exclusive examples of an optical coupling device 170 that may be included in, and/or form a portion of, wireless data modules 120 of electronic devices 100 according to the present disclosure. In FIG. 5, first electronic device 200 may include a first optical emitter 272, which may be configured to produce, or emit, wireless signal 142 responsive to receipt of an input electric signal 176, and/or a first optical detector 274, which may be configured to produce an output electric signal 178 responsive to receipt of wireless signal 142. Similarly, second electronic device 300 may include complementary second optical emitter 372 and/or second optical detector 374 configured to produce and/or receive the wireless signal.

Optical coupling device 170 also may include and/or be in optical communication with a waveguide 180, which also may be referred to herein as a terahertz waveguide. Waveguide 180 may be configured to transfer wireless signal 142 between complementary optical coupling devices 170 of first electronic device 200 and second electronic device 300.

The various components of optical coupling device 170 may be sized, designed, and/or configured to transmit electromagnetic radiation at any suitable electromagnetic radiation frequency. Illustrative, non-exclusive examples of electromagnetic radiation frequencies according to the present disclosure include electromagnetic radiation frequencies of 10⁹-10¹⁶ Hz, including frequencies of 10⁹, 10¹⁰, 10¹¹, 10¹², 10¹³, 10¹⁴, 10¹⁵, of 10¹⁶ Hz, though frequencies of less than 10⁹ Hz, as well as frequencies of greater than 10¹⁶ Hz are also within the scope of the present disclosure.

As discussed in more detail herein, wireless power modules 108 according to the present disclosure may include and/or be in electrical communication with a plurality of near-field power coupling devices 112. This is illustrated in FIG. 6, which is a top view of a schematic representation of illustrative, non-exclusive examples of an array 184 of near-field power coupling devices 112 according to the present disclosure that may be associated with an electronic device 100 according to the present disclosure, such as first electronic device 200 and/or second electronic device 300.

While FIG. 6 only illustrates array 184 that may be associated with one of first electronic device 200 or second electronic device 300, the other of first electronic device 200 and second electronic device 300 also may include a second, complementary array of near-field power coupling devices 112. As used herein the term “complementary” describes a pair of near-field coupling devices that are configured to work together and/or be in wireless communication with one another. This is illustrated in FIGS. 1-6, wherein one or more first near-field coupling devices associated with first electronic device 200 (such as wireless power module 108, wireless data module 120, first wireless power module 208, and/or first wireless data module 220) are proximal to, aligned with, and/or in wireless communication with one or more second near-field coupling devices associated with second electronic device 300 (such as wireless power module 108, wireless data module 120, second wireless power module 308, and/or second wireless data module 320).

The use of array 184 may provide for control of the overall coupling and/or the coupling efficiency between first electronic device 200 and second electronic device 300. As an illustrative, non-exclusive example, two conductive surfaces that are 20 um in diameter and separated by 1 um of a material having a dielectric constant of 10 form a capacitor with a capacitance of approximately 28 femtofarads (fF). One hundred of these capacitors connected in parallel have a capacitance of approximately 2.8 picofarads (pF) and a reactance of −j57 ohms at 1 GHz and −j5.7 ohms at 10 GHz. Thus, the capacitance of the individual capacitors, as well as the number of capacitors present within array 184, may be controlled to control the wireless coupling between first electronic device 200 and second electronic device 300.

As an illustrative, non-exclusive example, each of the near-field power coupling devices within array 184 may be in electrical communication with a coupling control circuit 190 that is configured to control a strength, magnitude, and/or transmission efficiency of the wireless power signal that is transmitted between first electronic device 200 and second electronic device 300. As an illustrative, non-exclusive example, coupling control circuit 190 may include a plurality of electrical conduits that are configured to electrically connect at least a portion of the near-field power coupling devices in any suitable series, parallel, and/or series-parallel arrangement to control the transmission of the wireless power signal. As another illustrative, non-exclusive example, coupling control circuit 190 may be configured to selectively control which of the plurality of near-field power coupling devices may be utilized to transmit the wireless power signal between the first electronic device and the second electronic device, such as by selectively including and/or selectively excluding portion(s) of array 184 from transmitting and/or receiving the wireless power signal. As an illustrative, non-exclusive example, when near-field power coupling devices 112 include a capacitor and/or an inductor, the coupling control circuit may be configured to adjust, or tune, a resonant frequency of the near-field power coupling device to improve the overall power transmission efficiency between first electronic device 200 and second electronic device 300 for a given frequency of the input AC signal that is provided to the near-field power coupling device.

While FIG. 6 shows nine near-field power coupling devices 112 arranged in a 3×3 grid, it is within the scope of the present disclosure that any suitable number of near-field power coupling devices may be utilized in any suitable arrangement. This may include more than nine and/or fewer than nine near-field power coupling devices arranged in any suitable layout. Similarly, the size, surface area, inductance, and/or capacitance of the individual near-field power coupling devices that comprise array 184 may vary in any suitable manner. As an illustrative, non-exclusive example, each of the near-field power coupling devices may include a similar, or at least substantially similar, size, surface area, inductance, and/or capacitance. As another illustrative, non-exclusive example, at least a first portion of the plurality of near-field power coupling devices may include a different, or at least substantially different, size, surface area, inductance, and/or capacitance than a second portion of the plurality of near-field power coupling devices.

Wireless power modules 108 may include both a positive and a negative near-field power coupling device 112 in order to form a complete electrical circuit. It is within the scope of the present disclosure that at least a portion of the positive near-field power coupling devices may be grouped together and/or physically separated from at least a portion of the negative near-field power coupling devices of the wireless power module in order to decrease capacitive effects between and/or among adjacent near-field power coupling devices of differing charge. In addition, array 184 may be constructed in any suitable manner. As an illustrative, non-exclusive example, array 184 may he constructed using through silicon via (TSV) technology, with near-field power coupling devices 112 being present on a first face of a semiconductor wafer and in electrical communication with a first end of a TSV, and with connecting and/or control circuitry for the array being present on a second face of the semiconductor wafer and in electrical communication with a second end of the TSV.

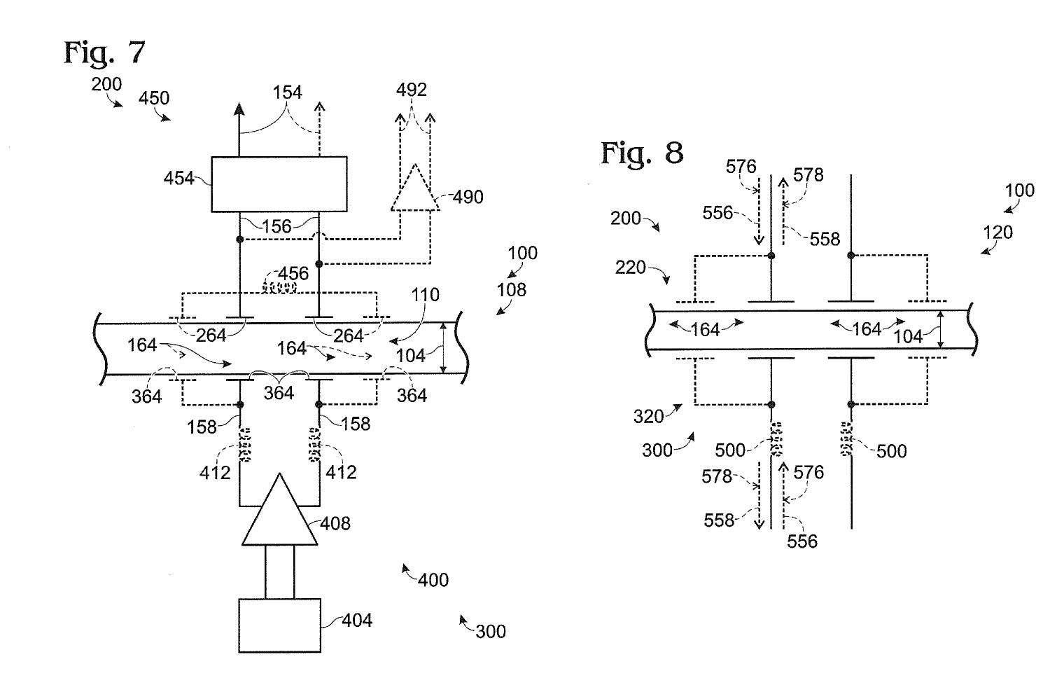

FIG. 7 provides less schematic but still illustrative, non-exclusive examples of wireless power modules 108 that may be utilized with the systems and methods according to the present disclosure. These wireless power modules may utilize a resonant circuit topography to efficiently couple electric power from a wireless power signal transmitter 400 associated with second electronic device 300 to a wireless power signal receiver 450 associated with first electronic device 200.

Wireless power signal transmitter 400 of FIG. 7 includes an AC generator 404 that is configured to produce an unamplified AC signal and to provide the unamplified AC signal to a power amplifier 408. Power amplifier 408 is configured to produce an amplified AC signal, which also may be referred to herein as an output AC signal 158, from the unamplified AC signal. The amplified AC signal may be provided in parallel to a pair of inductors 412 before being provided to a plurality of near-field power coupling devices in the form of a plurality of second conductive surfaces 364 that form a first portion of a plurality of capacitors 164. A portion of the plurality of second conductive surfaces 364 produces wireless power signal 110, which is provided to wireless power signal receiver 450.

AC generator 404 may include any suitable structure that is configured to produce, or generate, a suitable unamplified AC signal. An efficiency of power transfer between wireless power signal transmitter 400 and wireless power signal receiver 450 may increase as a frequency of the amplified AC signal that is utilized to produce the wireless power signal is increased. Thus, the frequency of the unamplified AC signal may be at least 0.5 GHz, including frequencies of at least 1 GHz, at least 2 GHz, at least 3.5 GHz, at least 5 GHz, at least 7.5 GHz, at least 10 GHz, at least 12.5 GHz, at least 15 GHz, at least 20 GHz, at least 25 GHz, at least 30 GHz, at least 35 GHz, at least 40 GHz, 0.5-40 GHz, 1-10 GHz, 1-15 GHz, 1-20 GHz, 5-10 GHz, or 5-15 GHz.

Power amplifier 408 any include any suitable structure that is configured to increase a voltage, current, and/or power of the unamplified AC signal produced by AC generator 404. Illustrative, non-exclusive examples of power amplifiers 408 according to the present disclosure include any suitable microwave power amplifier, operational amplifier, differential amplifier, microwave amplifier, and/or transistor pair.

Inductors 412 may be included in series with capacitors 164 to produce a series resonant circuit. An inductance of inductors 412 may be chosen to change, modify, and/or otherwise tune a resonant frequency of the series resonant circuit to increase the efficiency of power transfer between wireless power signal transmitter 400 and wireless power signal receiver 450. In addition, and as discussed in more detail herein, a coupling control circuit may be utilized to control a number and/or configuration of capacitors 164 that are included in the series resonant circuit to increase the power transfer efficiency.

Wireless power signal receiver 450 of FIG. 7 includes a plurality of first conductive surfaces 264 that form a second portion of the plurality of capacitors 164 and produce an input AC signal 156 from wireless power signal 110. The input AC signal is provided to an AC to DC converter 454, an illustrative, non-exclusive example of which includes a switching regulator, that is configured to receive the input AC signal and to produce one or more DC signals 154 therefrom. The one or more DC signals may be utilized to provide electric power to one or more electric circuits associated with first electronic device 200. The wireless power signal receiver also may include a DC return inductor 456.

A significant portion of the power consumption for a high speed logic device may be due to clock circuitry 490 that is utilized to create and/or distribute a clock signal 492 to the logic device. In the system of FIG. 7, a portion of input AC signal 156 may be utilized directly to power the clock circuitry. This may decrease and/or eliminate the need for an additional conversion of the DC signal into a clock signal, thereby decreasing unnecessary system components and increasing overall system efficiency.

It is within the scope of the present disclosure that any suitable resonant circuit may be used to couple the wireless power signal between wireless power signal transmitter 400 and wireless power signal receiver 450. As an illustrative, non-exclusive example, some and/or all of the series inductance may be located and/or placed on first electronic device 200. As another illustrative, non-exclusive example, any suitable number of capacitors 164 and/or series inductors 412 may be utilized. As yet another illustrative, non-exclusive example, a plurality of power amplifiers 408 may be utilized to generate the amplified AC signal.

A wave shape of the unamplified AC signal that is generated by AC generator 404 also may be varied to increase power transfer efficiency. Illustrative, non-exclusive examples of wave shapes according to the present disclosure include any periodic wave shape, including sinusoidal and square wave shapes. While not required, use of square or rectangular wave shapes may further increase the efficiency of power transfer by providing for operation of transistors associated with wireless power modules 108 in mostly on and off states.

When AC generator 404 includes a sinusoidal wave shape, series inductors 412 may be included within wireless power signal transmitter 400 in order to form a resonant circuit that resonates at, or near, the frequency of the AC generator. Additionally or alternatively, when AC generator 404 includes a square wave shape, DC return inductor 456 may he included within wireless power signal receiver 450 and the wireless power modules may be configured to resonate at odd harmonics of the square wave.

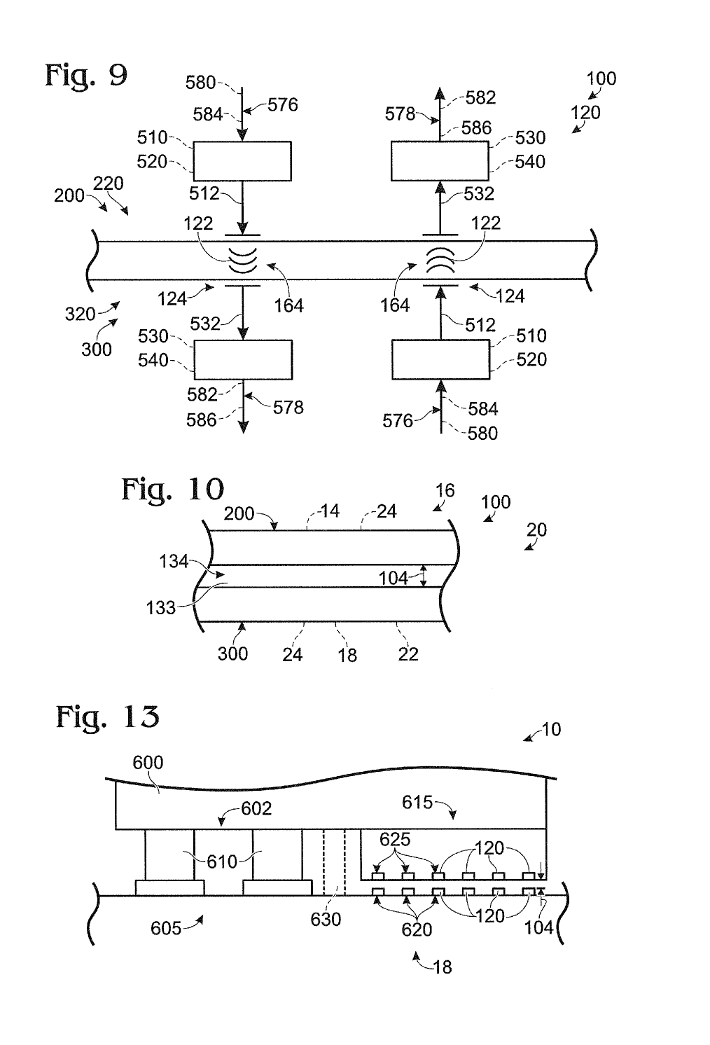

FIGS. 8-9 provide illustrative, non-exclusive examples of wireless data modules 120 that may be used with and/or form a portion of electronic devices 100 according to the present disclosure. As discussed in more detail herein, wireless data modules 120 may be configured to transfer a wireless data signal between first electronic device 200 and second electronic device 300. As an illustrative, non-exclusive example, a data signal, in the form of an input data signal 576, may be provided to first wireless data module 220, which may produce the wireless data signal therefrom. The wireless data signal may he received by second wireless data module 320, which may produce an output data signal 578 therefrom. The input and/or output electric signal may include any suitable data signal, illustrative, non-exclusive examples of which include high frequency (HF), or radio frequency (RF), data signals, low frequency (LF) data signals, and/or digital data signals.

FIG. 8 is a schematic representation of illustrative, non-exclusive examples of a wireless data module according to the present disclosure that may be configured to transfer a HF data signal with the wireless data signal. These high frequency data signals may include few and/or no frequency components that are below 0.5 GHz. This may include data signals with few and/or no frequency components below 1 GHz, below 2 GHz, below 3 GHz, below 4 GHz, below 5 GHz, below 6 GHz, below 7 GHz, below 8 GHz, below 9 GHz, or below 10 GHz.

The wireless data module of FIG. 8 includes two or more capacitors 164, the conductive surfaces of which may be separated by separation distance 104 between first electronic device 200 and second electronic device 300. The two or more capacitors may be configured to receive an input data signal 576, which may include input HF AC data signal 556, and to produce output data signal 578, which may include output HF AC data signal 558, therefrom. The wireless data module also may include one or more series inductors 500 that are configured to resonate with the one or more capacitors at or near the frequency of the input HF AC data signal.

FIG. 9 is a schematic representation of illustrative, non-exclusive examples of another wireless data module according to the present disclosure. The wireless data module of FIG. 9 may be configured to transfer a digital data signal or a low frequency data signal with the wireless data signal.

When input data signal 576 includes a digital input data signal 580, a digital output portion 510 may be configured to receive the digital input data signal and to produce an output AC data signal 512 therefrom. The output AC data signal may include a high frequency AC signal that may efficiently transfer wireless data signal 122 between first electronic device 200 and second electronic device 300 using near-field data coupling device 124, such as capacitor 164. Digital input portion 530 may receive an input AC data signal 532 from the near-field data coupling device and produce a digital output data signal 582, which may correspond to digital input data signal 580, therefrom.

Illustrative, non-exclusive examples of digital input portions 530 according to the present disclosure include any suitable receiver, Schmitt trigger, and/or amplifier. Illustrative, non-exclusive examples of digital output portions 510 according to the present disclosure include any suitable driver and/or amplifier.

When input data signal 576 includes a low frequency input data signal 584, such as a low frequency analog signal, a low frequency output portion 520 may be configured to receive low frequency input data signal 584 and to produce an output AC data signal 512 therefrom. The output AC data signal may include a high frequency AC signal that may efficiently transfer wireless data signal 122 between first electronic device 200 and second electronic device 300 using near-field data coupling device 124, such as capacitor 164. Low frequency input portion 540 may receive an input AC data signal 532 from the near-field data coupling device and produce a low frequency output data signal 586, which may correspond to low frequency input data signal 584, therefrom.

Illustrative, non-exclusive examples of low frequency output portions 520 according to the present disclosure include a pulse width modulator that is configured to modulate the low frequency input data signal onto a high frequency carrier signal to produce a wireless data signal that may be efficiently transferred by near-field data coupling device 124. Illustrative, non-exclusive examples of low frequency input portions 540 according to the present disclosure include a pulse width demodulator that is configured to demodulate the low frequency input data signal from the high frequency carrier signal to produce the low frequency output data signal.

As discussed in more detail herein, the systems and methods according to the present disclosure may be utilized to provide wireless, or non-contact, power and/or data communication between two electronic devices, or tiers, that may be proximal to but not in electrical contact with one another. As illustrative, non-exclusive examples, this may include power and/or data communication between a test tier and a device under test, power and/or data communication between a power supply tier and a logic tier, and/or power and/or data communication between a first logic tier and a second logic tier.

FIG. 10 is a schematic representation of illustrative, non-exclusive examples of an assembly 16 of electronic devices 100 according to the present disclosure. In FIG. 10, first electronic device 200 is operatively attached to and electrically isolated from second electronic device 300 by a dielectric adhesive 133. Dielectric adhesive 133 fills volume 134 between first electronic device 200 and second electronic device 300 and defines separation distance 104 therebetween.

The use of dielectric adhesive 133 to attach first electronic device 200 to second electronic device 300 may provide for simple, efficient, and/or cost-effective construction of assembly 16. In addition, dielectric adhesive 133 may be configured to provide for nondestructive separation of first electronic device 200 from second electronic device 300, such as through dissolution and/or melting of the dielectric adhesive. This may provide for the use of the systems and methods according to the present disclosure in test systems that may nondestructively test, or probe, the electrical properties of a device under test, as well as provide for reworking of an assembly of electronic devices that may include one or more defective, or malfunctioning, electronic devices. As used herein, the term “reworking” optionally may refer to any suitable process that is configured to repair and/or modify an assembly of electronic devices to replace and/or repair a defective, malfunctioning, or otherwise undesired portion thereof, restore a desired operational characteristic, and/or improve performance of the assembly of electronic devices.

Assembly 16 may include any suitable assembly of electronic devices 100. As an illustrative, non-exclusive example, first electronic device 200 may include a test tier 14, and second electronic device 300 may include a device under test 18, such as a logic tier 22 and/or a power supply tier 24. When first electronic device 200 includes test tier 14, it is within the scope of the present disclosure that any suitable number of devices under test may be in wireless communication with the test tier. As an illustrative, non-exclusive example, test tier 14 may include two generally opposed, planar surfaces and each of the surfaces may be operatively attached to and/or in wireless communication with a device under test. As another illustrative, non-exclusive example, a plurality of devices under test may be operatively attached to and/or in wireless communication with a single surface of test tier 14.

Additionally or alternatively, second electronic device 300 may include power supply tier 24, and first electronic device 200 may include logic tier 22, with the assembly forming a portion of a 3-D integrated circuit 20. It is within the scope of the present disclosure that 3-D integrated circuit 20 may include any suitable number of electronic devices 100, including 2, 3, 4, 5, 7, 10, or more than 10 electronic devices. This may include any suitable combination of logic and/or power supply tiers arranged in any suitable configuration.

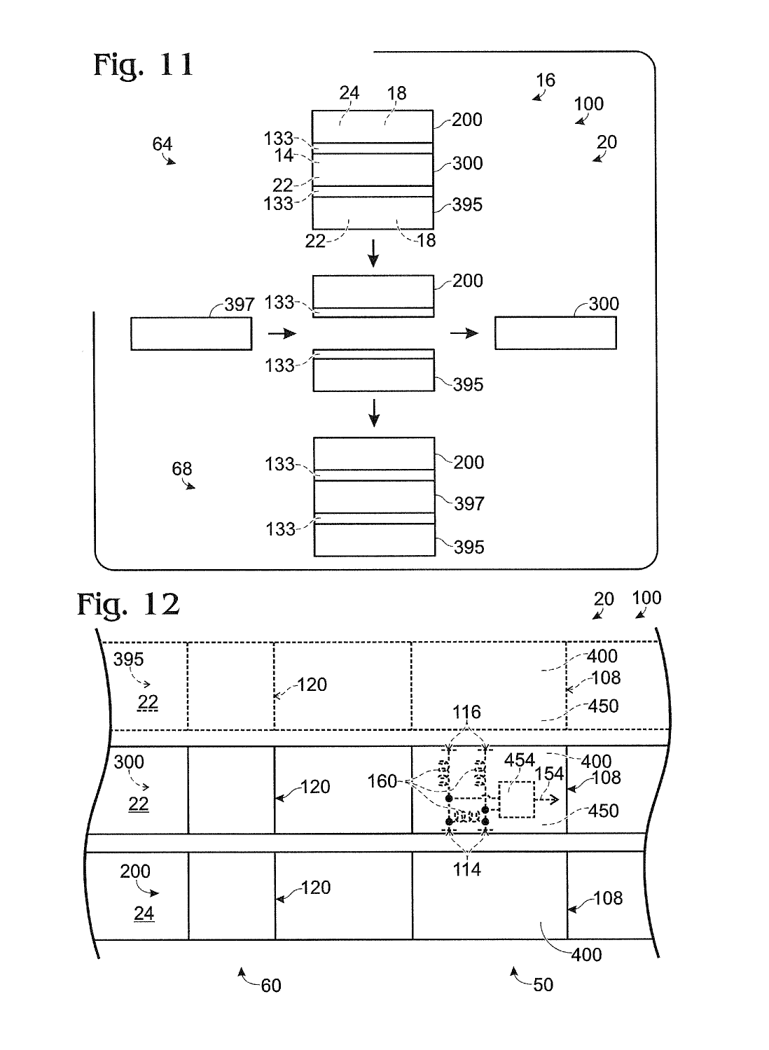

FIG. 11 is another schematic representation of illustrative, non-exclusive examples of an assembly 16 of electronic devices 100 according to the present disclosure. FIG. 11 illustrates that, as discussed in more detail herein with respect to FIG. 10, the systems and methods disclosed herein may provide for establishment of temporary, non-destructive power and/or data communication between electronic devices 100, such as may be utilized to test and/or rework the electronic devices and/or assemblies thereof.

In FIG. 11, initial assembly 64 includes first electronic device 200, second electronic device 300, and third electronic device 395. First electronic device 200 is in wireless communication with second electronic device 300 and may be operatively attached to second electronic device 300 with dielectric adhesive 133. Similarly, third electronic device 395 is in wireless communication with second electronic device 300 and may be operatively attached to the second electronic device with the dielectric adhesive.

As discussed in more detail herein, dielectric adhesive may be configured to be dissolved and/or melted to provide for non-destructive separation of first electronic device 200 from second electronic device 300 and/or separation of second electronic device 300 from third electronic device 395. It is within the scope of the present disclosure that the dielectric adhesive between first electronic device 200 and second electronic device 300 may be the same as, or at least substantially similar to, the dielectric adhesive between second electronic device 300 and third electronic device 395. However, it is also within the scope of the present disclosure that the dielectric adhesives may be different. As an illustrative, non-exclusive example, the use of different dielectric adhesives may provide for separation of first electronic device 200 from second electronic device 300 without separation of second electronic device 300 from third electronic device 395.

As an illustrative, non-exclusive example, second electronic device 300 may include a test tier 14, and first electronic device 200 and third electronic device 395 may include devices under test 18. As shown by the process flow in FIG. 11, subsequent to testing first electronic device 200 and third electronic device 395, the electronic devices may be separated from one another and test tier 14 may be replaced with fourth electronic device 397, as shown by final assembly 68. Final assembly 68 of second electronic device 200, fourth electronic device 397, and third electronic device 395 may form a 3-D integrated circuit 20.

As another illustrative, non-exclusive example, first electronic device 200 may include a power supply tier 24, and second electronic device 300 and third electronic device 395 may include logic tiers 22 that form a 3-D integrated circuit 20. Power supply tier 24 may be configured to provide a wireless power signal to logic tiers 22 and also may be configured to send one or more wireless data signals to and/or receive one or more wireless data signals from the logic tiers.

One or more test sequences performed on initial assembly 64 may determine that second electronic device 300 is defective, malfunctioning, and/or faulted. Thus, the process flow of FIG. 11 may include separation of first electronic device 200 and third electronic device 395 from malfunctioning second electronic device 300 and replacement of the malfunctioning second electronic device with an operational fourth electronic device 397 as shown by final assembly 68.

As yet another illustrative, non-exclusive example, one or more of the electronic devices included in initial assembly 64, such as second electronic device 300, may include a disposable electronic device that is configured to be utilized a limited number of times and then replaced. Under these conditions, second electronic device 300 may be replaced with fourth electronic device 397 using the process flow of FIG. 11, and final assembly 68 may be re-used.

FIG. 12 is a schematic representation of illustrative, non-exclusive examples of a 3-D integrated circuit 20 according to the present disclosure. The 3-D integrated circuit of FIG. 12 includes a plurality of electronic devices 100, including at least first electronic device 200 in the form of a power supply tier 24 and second electronic device 300 in the form of a first logic tier 22. As shown in dashed lines in FIG. 12, the 3-D integrated circuit also may include one or more additional electronic devices, such as third electronic device 395 that includes a second logic tier 22.

The 3-D integrated circuit of FIG. 12 includes at least one power bus 50 that is configured to wirelessly distribute one or more power signals among the plurality of electronic devices, as well as one or more data busses 60 that are configured to wirelessly distribute one or more data signals among the plurality of electronic devices. Power bus 50 may include any suitable structure that is configured to provide and/or distribute the power signal among the plurality of electronic devices, including wireless power modules 108 that are discussed in more detail herein. As an illustrative, non-exclusive example, power supply tier 24 may include wireless power signal transmitter 400. As another illustrative, non-exclusive example, one or more logic tiers 22 may include both wireless power signal transmitter 400 and wireless power signal receiver 450, as discussed in more detail herein with reference to FIG. 7.

A combined wireless power signal transmitter and receiver is shown in dashed lines in FIG. 12 as forming a portion of second electronic device 300. The combined wireless power signal transmitter and receiver includes one or more first near-field coupling devices 114 that are in wireless communication with first electronic device 200, as well as one or more second near-field coupling devices 116 that are in wireless communication with third electronic device 395. One or more inductors 160 may be utilized to tune a resonant frequency of the circuits contained within wireless power module 108 and/or provide for more efficient transfer of the wireless power signal therethrough. In addition, an AC to DC converter 454, such as a switching regulator, may produce a DC signal 154 from the wireless power signal to power the second electronic device.

Similarly, data bus 60 may include any suitable structure that is configured to provide and/or distribute the wireless data signal among the plurality of electronic devices, including wireless data modules 120 that are discussed in more detail herein. Thus first electronic device 200 may be configured to provide at least a portion of the wireless data signal to second electronic device 300, and second electronic device 300 may be configured to provide at least a portion of the wireless data signal to third electronic device 395, when present.

The use of a power supply tier that is separate from, but in wireless communication with, one or more logic tiers may provide for more efficient use of space within the 3-D integrated circuit, improved heat dissipation from the 3-D integrated circuit, and/or optimization of the individual electronic devices that comprise the 3-D integrated circuit for a specific functionality and/or task. As an illustrative, non-exclusive example, the heat generated by a power supply tier may lead to significant thermal expansion and/or contraction of the power supply tier when compared to a logic tier. This expansion and/or contraction may preclude the direct, physical attachment of the power supply tier to the logic tier due to device reliability concerns. Thus, the wireless transfer of the power supply signal between the power supply tier and the logic tier may provide a more robust 3-D integrated circuit architecture.

As another illustrative, non-exclusive example, construction of the power supply tier on a separate substrate from the logic tier may provide for the use of materials and/or methods of construction that are designed to improve the operation of both the power supply tier and the logic tier. As an illustrative, non-exclusive example, the power supply tier may include one or more heat dissipation structures that are configured to dissipate heat that is generated by the power supply tier. Illustrative, non-exclusive examples of heat dissipation structures include an epitaxial diamond heat spreader and/or micro-fluidic channels for coolant circulation.

As another illustrative, non-exclusive example, a manufacturing technology for the power supply tier may be different from a manufacturing technology for the logic tier. As an illustrative, non-exclusive example, this may include the use of a silicon substrate for the logic tier and a gallium arsenide substrate for the power supply tier.

As electronic devices trend toward larger numbers of discrete circuit elements with higher operating frequencies and smaller geometries on a single device substrate, the number of electrical contacts that may be made with a device under test during electrical testing of the device under test may increase substantially. Using contact testing and/or probing technologies, a probe head associated with a test system may only contact the device under test in a limited number of locations due to the contact forces between the individual test probes of the probe head and the device under test that are needed to ensure reliable electrical contact between the probe head and the device under test and/or geometric constraints.

FIG. 13 is a schematic representation of illustrative, non-exclusive examples of a dual-zone probe head 600 that may form a portion of a test station 10 according to the present disclosure. The dual-zone probe head may include a contact power supply region 602 that is configured to provide electrical communication with one or more power pads 605 of a device under test 18 through the use of one or more probe tips 610. The dual-zone probe head also may include a non-contact data transfer region 615 that is configured to wirelessly transfer a data signal between wireless data pads 620 of device under test 18 and wireless probe pads 625 of probe head 600. Wireless data pads 620 and/or wireless probe pads 625 may include any of the illustrative, non-exclusive examples of wireless data modules 120 that are discussed in more detail herein.

Probe tips 610 may include compliant probe tips that are configured to provide electrical contact between probe head 600 and device under test 18 over a range of separation distances 104 between wireless probe pads 625 and wireless data pads 620. As an illustrative, non-exclusive example, at least one of probe head 600 and device under test 19 may include one or more gap control structures 630 that are configured to physically contact the other of probe head 600 and device under test 19 and control separation distance 104. This may include controlling both the separation distance between individual pairs of wireless data pads 620 and wireless probe pads 625, as well as controlling an average separation distance and/or a variation in separation distances among all of the pairs of wireless data pads and wireless probe pads. As another illustrative, non-exclusive example, test station 10 may detect electronically a coupling among the plurality of wireless data pads 625 and the plurality of wireless probe pads 620 and adjust separation distance 104, the average separation distance, and/or the variation in separation distance based thereon.

Using the dual-zone probe head of FIG. 13, physical contact between the probe head and the device under test may be limited only to the region(s) of the device under test that include power pads 605. This may decrease the overall magnitude of the contact force between the probe head and the device under test and provide for testing a larger portion, or fraction, of the device under test at a given time when compared to testing methodologies that include making physical contact between the probe head and each power and/or data pad to be tested by the test system.

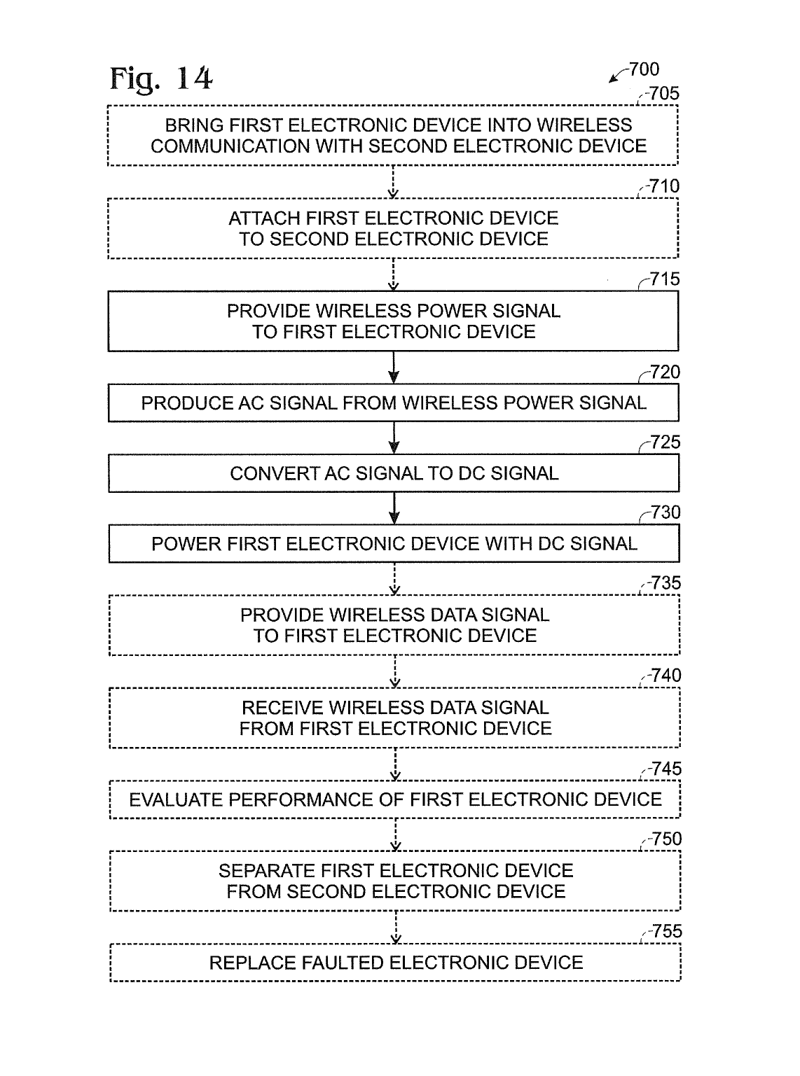

FIG. 14 is a flowchart depicting methods 700 according to the present disclosure of wirelessly transferring power and/or data signals between a plurality of electronic devices, such as a first electronic device and a second electronic device. The methods of FIG. 14 optionally may include bringing a first electronic device into wireless communication with a second electronic device at 705 and attaching the first electronic device to the second electronic device at 710. The methods then include providing a wireless power signal to the first electronic device at 715, producing an AC signal from the wireless power signal at 720, converting the AC signal to a DC signal at 725, and powering the first electronic device with the DC signal at 730. The methods optionally may include providing a wireless data signal to the first electronic device at 735, receiving a wireless data signal from the first electronic device at 740, evaluating a performance of the first electronic device at 745, separating the first electronic device from the second electronic device at 750, and/or replacing a faulted electronic device at 755.

Bringing the first electronic device into wireless communication with the second electronic device at 705 may, as discussed in more detail herein, include decreasing a separation distance between one or more near-field coupling devices of the first electronic device and one or more near-field coupling devices of the second electronic device such that the separation distance is less than a threshold value and/or within a threshold range of values. Illustrative, non-exclusive examples of separation distances between the first electronic device and the second electronic are discussed in more detail herein.

Attaching the first electronic device to the second electronic device at 710 may include the use of any suitable structure to operatively attach, at least temporarily, the first electronic device to the second electronic device. As an illustrative, non-exclusive example, and as discussed in more detail herein, the attaching may include the use of a dielectric adhesive to adhere the first electronic device to the second electronic device.

Providing the wireless power signal to the first electronic device at 715 may include the use of any suitable structure to wirelessly transfer the wireless power signal to the first electronic device. As an illustrative, non-exclusive example, the providing may include the use of one or more wireless power modules and/or wireless power signal transmitters on the second electronic device to produce the wireless power signal and the use of one or more wireless power modules and/or wireless power signal receivers on the first electronic device to receive the wireless power signal.

Producing the AC signal from the wireless power signal at 720 may include receiving the wireless power signal and converting the wireless power signal into an AC signal, or AC electric current. As an illustrative, non-exclusive example, this may include the use of a near-field power coupling device, such as an inductor and/or a capacitor, to convert the wireless power signal into the AC signal.

Converting the AC signal into a DC signal at 725 may include converting the AC electric current to the DC electric current on the first electronic device. This may include the use of any suitable AC to DC converter, such as a switching regulator, to perform the AC to DC conversion.

Powering the first electronic device with the DC signal at 730 may include providing the DC signal to one or more electric circuits that are present on the first electronic device and/or otherwise utilizing the DC signal to provide a motive force for operation of the one or more electric circuits contained on the first electronic device. As an illustrative, non-exclusive example, the powering may include powering one or more logic circuits present on the first electronic device.

Providing the wireless data signal to the first electronic device at 735 and/or receiving the wireless data signal from the first electronic device at 740 may include the use of any suitable structure to produce the wireless data signal and transfer the wireless data signal to and/or from the first electronic device. As an illustrative, non-exclusive example, the second electronic device may include one or more second wireless data modules that are configured to produce and/or receive the wireless data signal and the first electronic device may include one or more complementary first wireless data modules that are configured to produce and/or receive the wireless data signal. The providing may include the use of any suitable test sequence and/or providing any suitable test signal to test the operation of the first electronic device. Similarly, the receiving may include receiving any suitable resultant signal that is product based, at least in part, on the provided wireless power signal and/or the provided wireless data signal from the first electronic device.

Evaluating the performance of the first electronic device at 745 may include the use of any suitable indicator, test sequence, and/or comparison to assess the functionality of the first electronic device and/or categorize the performance of the first electronic device. As an illustrative, non-exclusive example, the evaluating may include detecting the presence and/or absence of a particular resultant signal. As another illustrative, non-exclusive example, the evaluating may include comparing the resultant signal to the test signal, the power signal, and/or tabulated, predetermined, and/or threshold resultant signal values. As another illustrative, non-exclusive example, the evaluating may include determining that the first electronic device is defective, malfunctioning, and/or faulted.

Separating the first electronic device from the second electronic device at 750 may include physically separating the first electronic device from the second electronic device and/or ceasing wireless communication between the first electronic device and the second electronic device. The separating may include separating in a non-destructive manner and/or separating without damage to the first electronic device and/or the second electronic device. As an illustrative, non-exclusive example, and when the attaching at 710 includes the use of a dielectric adhesive to attach the first electronic device to the second electronic device, the separating may include dissolving the dielectric adhesive.

Replacing the faulted electronic device at 755 may include replacing the first electronic device with a third electronic device that is substantially similar to the first electronic device responsive to determining that the first electronic device is defective, malfunctioning, and/or faulted. As an illustrative, non-exclusive example, the replacing may include bringing the third electronic device into wireless communication with the second electronic device, as discussed in more detail herein with reference to step 705, and/or attaching the third electronic device to the second electronic device, as discussed in more detail herein with reference to step 710.

Methods 700 may be utilized in a variety of circumstances, such as to provide for wireless tier-to-tier power and/or data transfer within a 3-D integrated circuit, to provide for reworking of a 3-D integrated circuit, and/or to provide for testing of an electronic device. As an illustrative, non-exclusive example, the first electronic device may include a power supply tier, and the second electronic device may include a logic tier, where the combination of the power supply tier and the logic tier forms at least a portion of a 3-D integrated circuit that may wirelessly transfer data and/or power therewithin using methods 700. Additionally or alternatively, methods 700 also may be utilized to rework the 3-D integrated circuit responsive to detection of a defect, malfunction, and/or fault in at least one of the power supply tier and the logic tier.

As another illustrative, non-exclusive example, the second electronic device may include a test tier that is in electrical communication with and/or forms a portion of a probe head and/or a test system. The test system may be configured to evaluate the operation and/or performance of the first electronic device, and methods 700 may be utilized to test the operation of the first electronic device.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. An electronic device, comprising:

a device substrate;

a first wireless power module on the device substrate and configured to transfer a wireless power signal between the electronic device and a second wireless power module; and

a first wireless data module on the device substrate and configured to transfer a wireless data signal between the electronic device and a second wireless data module.

A2. The electronic device of paragraph A1, wherein the wireless power signal and the wireless data signal do not include an electric current flow through an electrical conduit.

A3. The electronic device of any of paragraphs A1-A2, wherein the wireless power signal includes at least one of an electric field, a magnetic field, and electromagnetic radiation.

A4. The electronic device of any of paragraphs A1-A3, wherein the first wireless power module is configured to transfer the wireless power signal without at least one of electrical contact, physical contact, net electric current flow, and electrical conduction between the first wireless power module and the second wireless power module, and optionally wherein the first wireless power module is configured to transfer the wireless power signal without all of electrical contact, physical contact, net current flow, and electrical conduction between the first wireless power module and the second wireless power module.

A5. The electronic device of any of paragraphs A1-A4, wherein the first wireless data module is configured to transfer the wireless data signal without at least one of electrical contact, physical contact, net electric current flow, and electrical conduction between the first wireless data module and the second wireless data module, and optionally wherein the first wireless data module is configured to transfer the wireless data signal without all of electrical contact, physical contact, net current flow, and electrical conduction between the first wireless data module and the second wireless data module.

A6. The electronic device of any of paragraphs A1-A5, wherein the device substrate is a first substrate, wherein the second wireless power module and the second wireless data module are on a second substrate, and further wherein the first substrate is different from the second substrate.

A7. The electronic device of any of paragraphs A1-A6, wherein a minimum separation distance between the first wireless power module and the second wireless power module is less than 10 um, optionally including minimum separation distances of less than 8 um, less than 6 um, less than 5 um, less than 4 um, less than 3 um, less than 2 um, less than 1 um, less than 0.5 um, less than 0.25 um, or less than 0.1 um.

A8. The electronic device of any of paragraphs A1-A7, wherein a minimum separation distance between the first wireless data module and the second wireless data module is less than 10 um, optionally including minimum separation distances of less than 8 um, less than 6 um, less than 5 um, less than 4 um, less than 3 um, less than 2 um, less than 1 um, less than 0.5 um, less than 0.25 um, or less than 0.1 um.

A9. The electronic device of any of paragraphs A1-A8, wherein the wireless power signal includes at least one of an electric field, a magnetic field, and electromagnetic radiation, and optionally wherein a/the minimum separation distance between the first wireless power module and the second wireless power module is less than a wavelength of the wireless power signal, further optionally wherein the wireless power signal includes electromagnetic radiation and the minimum separation distance is less than 75%, less than 50%, less than 40%, less than 30%, less than 25%, less than 20%, less than 10%, less than 5%, or less than 1% of the wavelength of the electromagnetic radiation.

A10. The electronic device of any of paragraphs A1-A9, wherein the wireless data signal includes at least one of an electric field, a magnetic field, and electromagnetic radiation, and optionally wherein a/the minimum separation distance between the first wireless data module and the second wireless data module is less than a wavelength of the wireless data signal, further optionally wherein the wireless data signal includes electromagnetic radiation and the minimum separation distance is less than 75%, less than 50%, less than 40%, less than 30%, less than 25%, less than 20%, less than 10%, less than 5%, or less than 1% of the wavelength of the electromagnetic radiation.

A11. The electronic device of any of paragraphs A1-A10, wherein a/the minimum separation distance between the first wireless power module and the second wireless power module is at least 0.01 um, optionally including minimum separation distances of at least 0.025 um, at least 0.05 um, at least 0.075 um, at least 0.1 um, at least 0.25 um, at least 0.5 um, or at least 1 um.

A12. The electronic device of any of paragraphs A1-A11, wherein a/the minimum separation distance between the first wireless data module and the second wireless data module is at least 0.01 um, optionally including minimum separation distances of at least 0.025 um, at least 0.05 um, at least 0.075 um, at least 0.1 um, at least 0.25 um, at least 0.5 um, or at least 1 um.

A13. The electronic device of any of paragraphs A1-A12, wherein the first wireless power module includes a first near-field power coupling device configured to transfer the wireless power signal between the first wireless power module and a second near-field power coupling device of the second wireless power module.

A14. The electronic device of any of paragraphs A1-A13 wherein the first wireless power module includes a plurality of first near-field power coupling devices configured to transfer the wireless power signal between the plurality of first near-field power coupling devices and a plurality of second near-field power coupling devices of the second wireless power module.

A15. The electronic device of paragraph A14, wherein the plurality of first near-field power coupling devices includes at least 1,000 first near-field power coupling devices, optionally including at least 5,000, at least 10,000, at least 25,000, at least 50,000, at least 100,000, at least 250,000, at least 500,000, or at least 1,000,000 first near-field power coupling devices.

A16. The electronic device of any of paragraphs A1-A15, wherein the first wireless data module includes a first near-field data coupling device configured to transfer the wireless data signal between the first wireless data module and a second near-field data coupling device of the second wireless data module.

A17. The electronic device of any of paragraphs A1-A16, wherein the first wireless data module includes a plurality of first near-field data coupling devices configured to transfer the wireless data signal between the plurality of first near-field data coupling devices and a plurality of second near-field data coupling devices of the second wireless data module.

A18. The electronic device of paragraph A17, wherein the plurality of first near-field data coupling devices includes at least 1,000 first near-field data coupling devices, optionally including at least 5,000, at least 10,000, at least 25,000, at least 50,000, at least 100,000, at least 250,000, at least 500,000, or at least 1,000,000 first near-field data coupling devices.

A19. The electronic device of any of paragraphs A13-A18, wherein the first near-field power coupling device includes a first power inductor, and further wherein the electronic device is configured to inductively transfer the wireless power signal between the first power inductor and a second power inductor of the second near-field power coupling device.

A20. The electronic device of any of paragraphs A13-A19, wherein the first near-field power coupling device is in inductive communication with the second near-field power coupling device, and optionally wherein the first near-field power coupling device is configured to inductively transfer the wireless power signal between the first wireless power module and the second wireless power module.

A21. The electronic device of any of paragraphs A19-A20 when dependent from any of paragraphs A14-A18, wherein the electronic device includes an inductive power transfer control device configured to selectively control an inductance between the first near-field power coupling device and the second near-field power coupling device, optionally wherein the inductive power transfer control device is configured to selectively control the inductance by controlling a portion of the plurality of first near-field power coupling devices that are inductive communication with the plurality of second near-field power coupling devices, and further optionally wherein the inductive power transfer control device is configured to selectively control the inductance to increase an efficiency of the wireless power signal transfer between the first wireless power module and the second wireless power module.

A22. The electronic device of any of paragraphs A16-A21, wherein the first near-field data coupling device includes a first data inductor, and further wherein the electronic device is configured to inductively transfer the wireless data signal between the first data inductor and a second data inductor of the second near-field data coupling device.

A23. The electronic device of any of paragraphs A16-A22, wherein the first near-field data coupling device is in inductive communication with the second near-field data coupling device, and optionally wherein the first near-field data coupling device is configured to inductively transfer the wireless data signal between the first wireless data module and the second wireless data module.

A24. The electronic device of any of paragraphs A13-A23, wherein the first near-field power coupling device includes a first conductive power module surface, wherein the second near-field power coupling device includes a second conductive power module surface, and further wherein the first conductive power module surface and the second conductive power module surface are separated by a dielectric material and form a capacitor configured to capacitively transfer the wireless power signal between the first wireless power module and the second wireless power module.

A25. The electronic device of any of paragraphs A13-A24, wherein the first near-field power coupling device is in capacitive communication with the second near-field power coupling device, and optionally wherein the first near-field power coupling device is configured to capacitively transfer the wireless power signal between the first wireless power module and the second wireless power module.

A26. The electronic device of any of paragraphs A24-A25 when dependent from any of paragraphs A10-A17, wherein the electronic device includes a capacitive power transfer control device configured to selectively control a capacitance between the first near-field power coupling device and the second near-field power coupling device, optionally wherein the capacitive power transfer control device is configured to selectively control the capacitance by controlling a portion of the plurality of first near-field power coupling devices that are in capacitive communication with the plurality of second near-field power coupling devices, and further optionally wherein the capacitive power transfer control device is configured to selectively control the capacitance to increase an efficiency of the wireless power signal transfer between the first wireless power module and the second wireless power module.

A27. The electronic device of any of paragraphs A16-A26, wherein the first near-field data coupling device includes a first conductive data module surface, wherein the second near-field data coupling device includes a second conductive data module surface, and further wherein the first conductive data module surface and the second conductive data module surface are separated by a dielectric material and form a capacitor configured to capacitively transfer the wireless data signal between the first wireless data module and the second wireless data module.

A28. The electronic device of any of paragraphs A16-A27, wherein the first near-field data coupling device is in capacitive communication with the second near-field data coupling device, and optionally wherein the first near-field data coupling device is configured to capacitively transfer the wireless data signal between the first wireless data module and the second wireless data module.

A29. The electronic device of any of paragraphs A24-A28, wherein the dielectric material includes a dielectric constant of at least 1, optionally including a dielectric constant of at least 2, at least 4, at least 6, at least 8, at least 10, at least 12, at least 14, at least 16, at least 18, at least 20, at least 30, at least 50, or at least 100, and further optionally wherein the dielectric material includes air.

A30. The electronic device of any of paragraphs A24-A29, wherein a thickness of the dielectric material is less than 10 um, optionally including thicknesses of less than 8 um, less than 6 um, less than 5 um, less than 4 um, less than 3 um, less than 2 um, less than 1 um, less than 0.5 um, less than 0.25 um, or less than 0.1 um.

A31. The electronic device of any of paragraphs A24-A30, wherein a/the thickness of the dielectric material is at least 0.01 um, optionally including thicknesses of at least 0.025 um, at least 0.05 um, at least 0.075 um, at least 0.1 um, at least 0.25 um, at least 0.5 um, or at least 1 um.

A32. The electronic device of any of paragraphs A1-A31, wherein the first wireless data module includes a first optical module, wherein the wireless data signal includes an optical signal, and further wherein the first optical module is configured to transfer the optical signal between the electronic device and a second optical module associated with the second wireless data module.

A33. The electronic device of paragraph A32, wherein the first wireless data module includes at least one of a waveguide and a terahertz waveguide.

A34. The electronic device of any of paragraphs A32-A33, wherein the first wireless data module further includes an optical detector configured to convert the optical signal into an electrical signal.

A35. The electronic device of any of paragraphs A1-A34, wherein at least one of the first wireless power module and the second wireless power module includes at least one of an inductor, a capacitor, a switching regulator, an AC to DC converter, and an amplifier, and optionally wherein both of the first wireless power module and the second wireless power module include at least one of an inductor, a capacitor, a switching regulator, an AC to DC converter, and an amplifier.

A36. The electronic device of any of paragraphs A13-A35, wherein the first near-field power coupling device includes a plurality of conductive surfaces that form a portion of a plurality of capacitors configured to produce an AC signal from the wireless power signal.

A37. The electronic device of paragraph A36, wherein the first wireless power module includes a power converter configured to receive the AC signal from the first near-field power coupling device and convert the AC signal into a DC signal to power a circuit on the electronic device, and optionally wherein the power converter includes a switching regulator.

A38. The electronic device of any of paragraphs A36-A37, wherein the first wireless power module includes an inductor electrically connecting at least two of the plurality of conductive surfaces.

A39. The electronic device of any of paragraphs A36-A38, wherein the electronic device is configured to produce a clock signal from the AC signal, optionally wherein the electronic device is configured to produce the clock signal directly from the AC signal, optionally wherein the electronic device is configured to produce the clock signal from the AC signal without first converting the AC signal into the DC signal, and further optionally wherein the electronic device includes an amplifier configured to produce the clock signal from the AC signal.

A40. The electronic device of any of paragraphs A36-A39, wherein the first wireless power module further includes a plurality of inductors in series with the plurality of capacitors and configured to adjust a resonant frequency of the first wireless power module.

A41. The electronic device of any of paragraphs A13-A35, wherein the first near-field power coupling device includes a plurality of conductive surfaces that form a portion of a plurality of capacitors configured to convert an AC signal into the wireless power signal.

A42. The electronic device of paragraph A41, wherein the first near-field power coupling device further includes a plurality of inductors in series with the plurality of capacitors and configured to adjust a resonant frequency of the first wireless power module.

A43. The electronic device of any of paragraphs A41-A42, wherein the electronic device further includes a power amplifier configured to receive an unamplified AC signal and to provide an amplified AC signal to the first near-field power coupling device as the AC signal.

A44. The electronic device of paragraph A43, wherein the electronic device further includes an AC generator configured to produce the unamplified AC signal, and optionally wherein a frequency of the unamplified AC signal is at least 0.5 GHz, further optionally including frequencies of at least 1 GHz, at least 2 GHz, at least 2.5 GHz, at least 5 HGz, at least 7.5 GHz, at least 10 GHz, at least 12.5 GHz, at least 15 GHz, at least 20 GHz, at least 25 GHz, at least 30 GHz, at least 35 GHz, at least 40 GHz, 0.5-40 GHz, 1-10 GHz, 1-15 GHz, 1-20 GHz, 5-10 GHz, or 5-15 GHz.

A45. The electronic device of any of paragraphs A1-A44, wherein the wireless data signal is configured to transfer a digital data signal, wherein the first wireless data module includes a digital input portion configured to receive the wireless data signal and a digital output portion configured to provide the wireless data signal to the second wireless data module.

A46. The electronic device of paragraph A45, wherein the digital input portion includes a receiver configured to receive an AC input signal from the first near-field data coupling device and to produce the digital data signal therefrom, and optionally wherein the receiver includes an amplifier.

A47. The electronic device of any of paragraphs A45-A46, wherein the digital output portion includes a driver configured to receive the digital data signal and to provide an AC output signal to the first near-field data coupling device, and optionally wherein the driver includes an amplifier.

A48. The electronic device of any of paragraphs A1-A47, wherein the wireless data signal is configured to transfer a radio frequency data signal, and further wherein the first wireless data module includes a radio frequency input portion configured to receive the wireless data signal from the second wireless data module and a radio frequency output portion configured to provide the wireless data signal to the second wireless data module.

A49. The electronic device of paragraph A48, wherein the digital input portion includes at least one of a capacitor, a portion of a capacitor, an inductor, a capacitor and an inductor in series, and a portion of a capacitor and an inductor in series.

A50. The electronic device of any of paragraphs A48-A49, wherein the digital output portion includes at least one of a capacitor, a portion of a capacitor, an inductor, a capacitor and an inductor in series, and a portion of a capacitor and an inductor in series.

A51. The electronic device of any of paragraphs A1-A50, wherein the wireless data signal is configured to transmit a low frequency analog signal, wherein the first wireless data module includes a low frequency input portion configured to receive the wireless data signal from the second wireless data module and a low frequency output portion configured to provide the wireless data signal to the second wireless module.

A52. The electronic device of paragraph A51, wherein the low frequency output portion includes a pulse width modulator configured to modulate the low frequency analog signal onto a high frequency carrier signal to produce the wireless data signal.

A53. The electronic device of paragraph A52, wherein the low frequency input portion includes a pulse width demodulator configured to demodulate the low frequency analog signal from the high frequency carrier signal.

A54. The electronic device of any of paragraphs A1-A53, wherein the device substrate includes at least one of silicon, gallium arsenide, and germanium.

A55. The electronic device of any of paragraphs A1-A54, wherein at least one of the first wireless power module and the first wireless data module is operatively attached to the device substrate, and optionally wherein both of the first wireless power module and the first wireless data module are operatively attached to the device substrate.

A56. The electronic device of any of paragraphs A1-A55, wherein at least one of the first wireless power module and the first wireless data module is formed from the device substrate, and optionally wherein both of the first wireless power module and the first wireless data module are formed from the device substrate.

A57. The electronic device of any of paragraphs A1-A56, wherein at least one of the first wireless power module and the first wireless data module is at least one of deposited onto, etched into, annealed into, grown on, and implanted into the device substrate, and optionally wherein both of the first wireless power module and the first wireless data module are at least one of deposited onto, etched into, annealed into, grown on, and implanted into the device substrate.

A58. The electronic device of any of paragraphs A6-A57, wherein the first substrate includes a plurality of alignment marks configured to increase an accuracy of alignment between the first substrate and the second substrate, and optionally wherein the plurality of alignment marks include a plurality of optically visible reference structures.

A59. The electronic device of paragraph A58, wherein the plurality of alignment marks are configured to provide a reference point for alignment of the first substrate with respect to the second substrate.

A60. The electronic device of any of paragraphs A58-A59, wherein the plurality of alignment marks are configured to provide a reference point for locating the first wireless power module with respect to the second wireless power module and for locating the first wireless data module with respect to the second wireless data module.

A61. The electronic device of any of paragraphs A1-A60, wherein a portion of a surface of the electronic device that receives at least one of the wireless power signal and the wireless data signal is a passivated surface, optionally wherein the portions of the surface of the electronic device that receive both the wireless power signal and the wireless data signal are passivated surfaces.

A62. The electronic device of paragraph A61, wherein all of the surface of the electronic device includes the passivated surface.

A63. The electronic device of any of paragraphs A61-A62, wherein the passivated surface is covered with an electrically insulating material, and optionally wherein the electrically insulating material includes at least one of a dielectric coating, a dielectric film, a polymeric material, and an oxide.

B1. A logic tier configured to perform a logical operation, the logic tier comprising:

the electronic device of any of paragraphs A1-A63, wherein the first wireless power module is a powered module configured to receive the wireless power signal and to produce a/the DC signal therefrom, and further wherein the first wireless data module is configured to produce an input data signal from a first portion of the wireless data signal and to produce a second portion of the wireless data signal from an output data signal; and

a logic device configured to be powered by the DC signal, wherein the logic device is configured to receive the input data signal and produce the output data signal therefrom.

B2. The logic tier of paragraph B1, wherein the logic device includes at least one of a logic circuit, an integrated circuit, a digital circuit, and an analog circuit.

C1. A power supply tier configured to provide power to a logic tier, the power supply tier comprising:

the electronic device of any of paragraphs A1-A63, wherein the first wireless power module is a power supply module configured to produce the wireless power signal.

D1. A test tier configured to wirelessly transfer electric power and an input data signal to a device under test, and to receive an output data signal therefrom, the test tier comprising:

the electronic device of any of paragraphs A1-A63, wherein the first wireless power module is a power supply module configured to produce the wireless power signal, and further wherein the first wireless data module is configured to produce a first portion of the wireless data signal from the input data signal and to produce the output data signal from a second portion of the wireless data signal.

D2. The test tier of paragraph D1, wherein the test tier includes a wired power connection configured to provide electric power to the test tier to produce the wireless power signal.

D3. The test tier of any of paragraphs D1-D2, wherein the test tier includes a wired input connection configured to provide the input data signal from a test system to the test tier.

D4. The test tier of any of paragraphs D1-D3, wherein the test tier includes a wired output connection configured to provide the output data signal from the test tier to a/the test system.

D5. The test tier of any of paragraphs D1-D4, wherein the test tier is configured to be in wireless communication with the logic tier of any of paragraphs B1-B2, and optionally wherein the test tier is configured to be inserted between and in wireless communication with two of the logic tiers of any of paragraphs B1-B2.

E1. A system for testing a device under test, the system comprising:

a signal generator configured to provide an input signal to the device under test;

a signal analyzer configured to receive an output signal from the device under test;

a power source configured to provide an electric current to the device under test; and

a probe head, wherein the probe head includes the test tier of any of paragraphs D1-D5, wherein the test tier is configured to provide the wireless power signal to the device under test, wherein the test tier is configured to provide the input data signal to the device under test, and further wherein the test tier is configured to receive the output data signal from the device under test.

E2. The system of paragraph E1, wherein the device under test includes the logic tier of any of paragraphs B1-B2.

E3. The system of any of paragraphs E1-E2, wherein the test tier is operatively attached to the device under test, and optionally wherein the test tier is operatively attached to the device under test with a dielectric adhesive.

E4. The system of paragraph E3, wherein the test tier is configured to be separated from the device under test after completion of a test sequence, and optionally wherein the dielectric adhesive is configured to be dissolved to separate the test tier from the device under test.

F1. A three-dimensional integrated circuit comprising:

the logic tier of any of paragraphs B1-B2; and

the power supply tier of paragraph C1, wherein the power supply tier is configured to provide the wireless power signal to the logic tier.

F2. The three-dimensional integrated circuit of paragraph F1, wherein a manufacturing technology for the power supply tier is different from a manufacturing technology for the logic tier.

F3. The three-dimensional integrated circuit of any of paragraphs F1-F2, wherein the device substrate for the logic tier includes a silicon wafer, and further wherein the device substrate for the power supply tier includes a gallium arsenide wafer.

F4. The three-dimensional integrated circuit of any of paragraphs F1-F3, wherein the power supply tier is configured to at least one of transmit the wireless data signal to and receive the wireless data signal from the logic tier.

F5. The three-dimensional integrated circuit of any of paragraphs F1-F4, wherein the logic tier is a first logic tier, and further wherein the three-dimensional integrated circuit further includes at least a second logic tier.

F6. The three-dimensional integrated circuit of paragraph F5, wherein the first logic tier is configured to provide the power supply signal to the at least a second logic tier, and further wherein the first logic tier is configured to at least one of transmit the wireless data signal to and receive the wireless data signal from the at least a second logic tier.

F7. The three-dimensional integrated circuit of any of paragraphs F1-F6, wherein the power supply tier is operatively attached to the logic tier, optionally wherein the power supply tier is operatively attached to the logic tier with a dielectric adhesive.

F8. The three-dimensional integrated circuit of paragraph F7, wherein the power supply tier is configured to be separated from the logic tier to rework the three-dimensional integrated circuit responsive to detection of a malfunction in at least one of the power supply tier and the logic tier, and optionally wherein the dielectric adhesive is configured to be dissolved to separate the power supply tier from the logic tier.

G1. A method of wirelessly providing electric power and data communication to an electronic device, the method comprising:

providing a wireless power signal to the electronic device, wherein the providing a wireless power signal includes providing at least one of an electric field, a magnetic field, and electromagnetic radiation to a near-field power coupling device of the electronic device and producing an AC signal therefrom;

converting the AC signal to a DC signal on the electronic device;

powering the electronic device with the DC signal;

providing a wireless data signal to the electronic device, wherein the providing a wireless data signal includes providing at least one of an electric field, a magnetic field, and electromagnetic radiation to a near-field data coupling device and producing an input data signal from the near-field data coupling device; and

receiving a wireless data signal from the electronic device, wherein the receiving includes providing an output data signal to the near-field data coupling device and producing at least one of an electric field, a magnetic field, and electromagnetic radiation therefrom.

G2. The method of paragraph G1, wherein the near-field power coupling device is a first near-field power coupling device on a first substrate, wherein the providing a wireless power signal includes providing the wireless power signal from a second near-field power coupling device on a second substrate, and further wherein a minimum separation distance between the first substrate and the second substrate is less than 10 um, optionally including minimum separation distances of less than 8 um, less than 6 um, less than 5 um, less than 4 um, less than 3 um, less than 2 um, less than 1 um, less than 0.5 um, less than 0.25 um, or less than 0.1 um.

G3. The method of any of paragraphs G1-G2, wherein the near-field data coupling device is a first near-field data coupling device on the first substrate, wherein the providing a wireless data signal and the receiving include wirelessly communicating between the first near-field data coupling device and a second near-field data coupling device on a/the second substrate, and further wherein a/the minimum separation distance between the first substrate and the second substrate is less than 10 um, optionally including minimum separation distances of less than 8 um, less than 6 um, less than 5 um, less than 4 um, less than 3 um, less than 2 um, less than 1 um, less than 0.5 um, less than 0.25 um, or less than 0.1 um.

G4. The method of paragraph G3, wherein the electronic device includes a logic tier on the first substrate, wherein the second substrate includes a test tier, and further wherein, prior to the providing, the method includes bringing the logic tier into wireless communication with the test tier.

G5. The method of paragraph G4, wherein the bringing includes adhering the logic tier to the test tier with a dielectric adhesive.

G6. The method of paragraph G5, wherein the method further includes separating the logic tier from the test tier subsequent to completion of a test sequence.

G7. The method of paragraph G6, wherein the separating includes dissolving the dielectric adhesive.

G8. The method of paragraph G3, wherein the electronic device includes a logic tier on the first substrate, wherein the second substrate includes a power supply tier, and further wherein prior to the providing a wireless power signal and the providing a wireless data signal, the method includes bringing the logic tier into wireless communication with the power supply tier.

G9. The method of paragraph G8, wherein the bringing includes adhering the logic tier to the power supply tier with a dielectric adhesive.

G10. The method of paragraph G9, wherein the method further includes separating the logic tier from the power supply tier responsive to detecting a fault in at least one of the logic tier and the power supply tier.

G11. The method of paragraph G6, wherein the separating includes dissolving the dielectric adhesive.

G12. The method of any of paragraphs G6-G7, wherein the method further includes replacing a faulted one of the logic tier and the power supply tier and repeating the method.

H1. The use of the electronic device of any of paragraphs A1-A63, the logic tier of any of paragraphs B1-B2, the power supply tier of paragraph C1, the test tier of any of paragraphs D1-D5, the test system of any of paragraphs E1-E4, or the three-dimensional integrated circuit of any of paragraphs F1-F8 with the method of any of paragraphs G1-G12.

H2. The use of the method of any of paragraphs G1-G12 with the electronic device of any of paragraphs A1-A63, the logic tier of any of paragraphs B1-B2, the power supply tier of paragraph C1, the test tier of any of paragraphs D1-D5, the test system of any of paragraphs E1-E4, or the three-dimensional integrated circuit of any of paragraphs F1-F8.

H3. The use of a test tier to wirelessly power and test a logic tier.

H4. The use of a power supply tier to wirelessly power a logic tier.

H5. The use of a near-field power coupling device to wirelessly power an electronic device.

### INDUSTRIAL APPLICABILITY

The systems and methods disclosed herein are applicable to the electronic device manufacturing, assembly, and/or test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An electronic device, comprising:
a device substrate;
a first wireless power module on the device substrate and configured to transfer a wireless power signal between the electronic device and a second wireless power module, wherein a separation distance between the first wireless power module and the second wireless power module is less than 10 um; and
a first wireless data module on the device substrate and configured to transfer a wireless data signal between the electronic device and a second wireless data module, wherein a separation distance between the first wireless data module and the second wireless data module is less than 10 um.

2. The electronic device of claim 1, wherein the device substrate is a first substrate, wherein the second wireless power module and the second wireless data module are on a second substrate, and further wherein the first substrate is different from the second substrate.

3. The electronic device of claim 1, wherein the second wireless power module includes a second near-field power coupling device, and further wherein the first wireless power module includes a first near-field power coupling device configured to transfer the wireless power signal between the first wireless power module and the second near-field power coupling device of the second wireless power module.

4. The electronic device of claim 3, wherein the second near-field power coupling device includes a second power inductor, and further wherein the first near-field power coupling device includes a first power inductor, and further wherein the electronic device is configured to inductively transfer the wireless power signal between the first power inductor and the second power inductor of the second near-field power coupling device.

5. The electronic device of claim 4, wherein the second wireless power module includes a plurality of second near-field power coupling devices, wherein the first wireless power module includes a plurality of first near-field power coupling devices configured to transfer the wireless power signal between the plurality of first near-field power coupling devices and the plurality of second near-field power coupling devices of the second wireless power module, and further wherein the electronic device includes an inductive power transfer control device configured to selectively control an inductance between the first near-field power coupling device and the second near-field power coupling device by controlling a portion of the plurality of first near-field power coupling devices that are in inductive communication with the plurality of second near-field power coupling devices.

6. The electronic device of claim 3, wherein the first near-field power coupling device includes a first conductive power module surface, wherein the second near-field power coupling device includes a second conductive power module surface, and further wherein the first conductive power module surface and the second conductive power module surface are separated by a dielectric material and form a capacitor configured to capacitively transfer the wireless power signal between the first wireless power module and the second wireless power module.

7. The electronic device of claim 6, wherein the second wireless power module includes a plurality of second near-field power coupling devices, wherein the first wireless power module includes a plurality of first near-field power coupling devices configured to transfer the wireless power signal between the plurality of first near-field power coupling devices and the plurality of second near-field power coupling devices of the second wireless power module, and further wherein the electronic device includes a capacitive power transfer control device configured to selectively control a capacitance between the first near-field power coupling device and the second near-field power coupling device by controlling a portion of the plurality of first near-field power coupling devices that are in capacitive communication with the plurality of second near-field power coupling devices.

8. The electronic device of claim 3, wherein the first near-field power coupling device includes a plurality of conductive surfaces that form a portion of a plurality of capacitors configured to produce an AC signal from the wireless power signal, wherein the first near-field power coupling device also includes an inductor configured to electrically connect at least two of the plurality of conductive surfaces, and further wherein the first wireless power module includes a power converter configured to receive the AC signal from the first near-field power coupling device and convert the AC signal into a DC signal to power a circuit on the electronic device.

9. The electronic device of claim 8, wherein the electronic device is configured to produce a clock signal directly from the AC signal without first converting the AC signal into the DC signal.

10. The electronic device of claim 3, wherein the first near-field power coupling device includes a plurality of conductive surfaces that form a portion of a plurality of capacitors configured to convert an AC signal into the wireless power signal, wherein the electronic device includes a power amplifier configured to receive an unamplified AC signal and to provide an amplified AC signal to the first near-field power coupling device as the AC signal, and further wherein the electronic device includes an AC generator configured to produce the unamplified AC signal, wherein a frequency of the unamplified AC signal is at least 1.0 GHz.

11. The electronic device of claim 1, wherein the second wireless data module includes a second near-field data coupling device, and further wherein the first wireless data module includes a first near-field data coupling device configured to transfer the wireless data signal between the first wireless data module and the second near-field data coupling device of the second wireless data module.

12. The electronic device of claim 11, wherein the second near-field data coupling device includes a second data inductor, and further wherein the first near-field data coupling device includes a first data inductor, and further wherein the electronic device is configured to inductively transfer the wireless data signal between the first data inductor and the second data inductor of the second near-field data coupling device.

13. The electronic device of claim 11, wherein the first near-field data coupling device includes a first conductive data module surface, wherein the second near-field data coupling device includes a second conductive data module surface, and further wherein the first conductive data module surface and the second conductive data module surface are separated by a dielectric material and form a capacitor configured to capacitively transfer the wireless data signal between the first wireless data module and the second wireless data module.

14. The electronic device of claim 11, wherein the wireless data signal is configured to transfer a radio frequency data signal, and further wherein the first wireless data module includes a radio frequency input portion configured to receive the wireless data signal from the second wireless data module and a radio frequency output portion configured to provide the wireless data signal to the second wireless data module.

15. The electronic device of claim 11, wherein the wireless data signal is configured to transfer a digital data signal, wherein the first wireless data module includes a digital input portion configured to receive an AC input signal from the first near-field data coupling device and to produce the digital data signal therefrom and a digital output portion configured to provide an AC output signal to the first near-field data coupling device.

16. The electronic device of claim 15, wherein the digital input portion includes at least one of a capacitor, a portion of a capacitor, an inductor, a capacitor and an inductor in series, and a portion of a capacitor and an inductor in series, and further wherein the digital output portion includes at least one of a capacitor, a portion of a capacitor, an inductor, a capacitor and an inductor in series, and a portion of a capacitor and an inductor in series.

17. The electronic device of claim 1, wherein the wireless data signal is configured to transmit a low frequency analog signal, wherein the first wireless data module includes a low frequency input portion configured to receive the wireless data signal from the second wireless data module and a low frequency output portion configured to provide the wireless data signal to the second wireless module, wherein the low frequency output portion includes a pulse width modulator configured to modulate the low frequency analog signal onto a high frequency carrier signal to produce the wireless data signal, and further wherein the low frequency input portion includes a pulse width demodulator configured to demodulate the low frequency analog signal from the high frequency carrier signal.

18. The electronic device of claim 1, wherein the first wireless data module includes a first optical module, wherein the wireless data signal includes an optical signal, and further wherein the first optical module is configured to transfer the optical signal between the electronic device and a second optical module associated with the second wireless data module.

19. The electronic device of claim 1, wherein portions of a surface of the electronic device that receive both the wireless power signal and the wireless data signal are passivated.

20. A logic tier configured to perform a logical operation, the logic tier comprising:
the electronic device of claim 1, wherein the first wireless power module is a powered module configured to receive the wireless power signal and to produce a DC signal therefrom, and further wherein the first wireless data module is configured to produce an input data signal from a first portion of the wireless data signal and to produce a second portion of the wireless data signal from an output data signal; and
a logic device configured to be powered by the DC signal, wherein the logic device is configured to receive the input data signal and produce the output data signal therefrom.

21. A three-dimensional integrated circuit comprising:
the logic tier of claim 20; and
a power supply tier configured to provide the wireless power signal to the logic tier.

22. The three-dimensional integrated circuit of claim 21, wherein the device substrate for the logic tier includes a silicon wafer, and further wherein a substrate for the power supply tier includes a gallium arsenide wafer.

23. A power supply tier configured to provide power to a logic tier, the power supply tier comprising:
the electronic device of claim 1, wherein the first wireless power module is a power supply module configured to produce the wireless power signal.

24. A test tier configured to wirelessly transfer electric power and an input data signal to a device under test, and to receive an output data signal therefrom, the test tier comprising:
the electronic device of claim 1, wherein the first wireless power module is a power supply module configured to produce the wireless power signal, and further wherein the first wireless data module is configured to produce a first portion of the wireless data signal from the input data signal and to produce the output data signal from a second portion of the wireless data signal.

25. A system for testing a device under test, the system comprising:
a signal generator configured to provide an input signal to a device under test;
a signal analyzer configured to receive an output signal from the device under test;
a power source configured to provide an electric current to the device under test; and
a probe head, wherein the probe head includes the test tier of claim 24, wherein the test tier is configured to provide the wireless power signal from the power source to the device under test, wherein the test tier is configured to provide the input data signal from the signal generator to the device under test, and further wherein the test tier is configured to provide the output data signal from the device under test to the signal analyzer.

26. A method of wirelessly providing electric power and data communication to an electronic device, the method comprising:
providing a wireless power signal to the electronic device, wherein the providing a wireless power signal includes providing at least one of an electric field, a magnetic field, and electromagnetic radiation to a near-field power coupling device of the electronic device and producing an AC signal therefrom;
converting the AC signal to a DC signal on the electronic device;
powering the electronic device with the DC signal;
providing a wireless input data signal to the electronic device, wherein the providing a wireless input data signal includes providing at least one of an electric field, a magnetic field, and electromagnetic radiation to a near-field data coupling device and producing an input data signal from the near-field data coupling device; and
receiving a wireless output data signal from the electronic device, wherein the receiving includes providing an output data signal to the near-field data coupling device and producing at least one of an electric field, a magnetic field, and electromagnetic radiation therefrom.

27. The method of claim 26, wherein the near-field power coupling device is a first near-field power coupling device on a first substrate, wherein the providing the wireless power signal includes providing the wireless power signal from a second near-field power coupling device on a second substrate, wherein the near-field data coupling device is a first near-field data coupling device on the first substrate, wherein a separation distance between the first substrate and the second substrate is less than 10 and further wherein the providing the wireless input data signal and receiving the wireless output data signal include wirelessly communicating between the first near-field data coupling device and a second near-field data coupling device on the second substrate.

28. The method of claim 27, wherein the electronic device includes a logic tier on the first substrate, wherein the second substrate includes a test tier, and further wherein, prior to the providing, the method includes bringing the logic tier into wireless communication with the test tier.

29. The method of claim 28, wherein the method further includes separating the logic tier from the test tier subsequent to completion of a test sequence.

30. The method of claim 27, wherein the electronic device includes a logic tier on the first substrate, wherein the second substrate includes a power supply tier, and further wherein prior to the providing a wireless power signal and the providing a wireless data signal, the method includes bringing the logic tier into wireless communication with the power supply tier.

31. The method of claim 30, wherein the method includes separating the logic tier from the power supply tier responsive to detecting a fault in at least one of the logic tier and the power supply tier, and further wherein the method includes replacing a faulted one of the logic tier and the power supply tier and repeating the method.
